(19) United States
(12) Patent Application Publication
(10) Pub. No.: US 2025/0051583 A1
(43) Pub. Date: Feb. 13, 2025

(54) FOULING RELEASE COATING COMPOSITION

(71) Applicant: JOTUN A/S, Sandefjord (NO)

(72) Inventors: Aslan M. ESMURZIEV, Sandefjord (NO); Anna Maria SZCZOTOK-PIECHACZEK, Sandefjord (NO); Naser ESMAEILI, Sandefjord (NO)

(21) Appl. No.: 18/719,953

(22) PCT Filed: Dec. 15, 2022
(86) PCT No.: PCT/EP2022/086178

§ 371 Date: Jun. 14, 2024

(30) Foreign Application Priority Data
Dec. 15, 2021 (EP) 21214881.1

(51) Int. Cl. C09D 5/16; B05D 5/08; B05D 7/00; C08G 77/04; C08K 3/22; C08K 3/26; C09D 5/02; C09D 5/14; C09D 7/61; C09D 7/80; C09D 183/12

(52) U.S. Cl. CPC C09D 5/1675; B05D 5/08; B05D 7/546; C08G 77/04; C08K 3/26; C09D 5/028; C09D 5/14; C09D 7/61; C09D 7/80; C09D 183/12; B05D 2301/00; B05D 2350/60; B05D 2401/20; B05D 2420/01; B05D 2420/02; B05D 2451/00; B05D 2504/00; B05D 2518/12; B05D 2601/02; B05D 2601/20; C08K 2003/2268

(57) ABSTRACT

The invention provides a waterborne fouling release coating composition comprising (a) an aqueous polysiloxane-based binder emulsion, wherein said emulsion comprises polysiloxane-based binder droplets having an average droplet size of 4 to 1000 n; and (b) at least one pigment or filler; wherein the coating composition comprises at least 10 wt % water relative to the total weight of L the composition as a whole.

This invention relates to fouling release coating compositions. In particular, the invention provides a waterborne fouling release composition comprising an aqueous polysiloxane-based binder emulsion. The invention further relates to a process for preparing the fouling release composition, a coating system comprising the composition and to substrates coated with the coating composition.

### BACKGROUND

Fouling release coatings are used on marine vessels to prevent fouling by marine organisms. These work on the principle that the fouling release surface has a very low coefficient of friction and hence it is challenging for marine organisms to cling to the surface, especially when a vessel is underway and hence the action of the sea can wash marine organisms from the hull.

Commercial vessels (e.g. container ships, bulk carriers, tankers, passenger ships) often operate in different waters, in different trade, with different activity, including idle periods. Fouling Release coatings having a very smooth surface and low surface energy minimise the chance of the adhesion of fouling to the surface and thereby provide good fouling protection.

Fouling release coatings are therefore characterized by low surface tension and low modulus of elasticity so that biofouling does not stick to the surface or the biofouling is easily washed off by the friction of the water against the surface.

Such coatings often comprise polysiloxane-based binders having reactive (curable) groups such as hydroxyl or silyl units, for example as disclosed in WO2021/105429 A1 and WO 2018/134124. A polysiloxane-based binder can be hydrolyzed and condensed in the presence of moisture and catalysts.

The coating industry is constantly faced with stricter VOC regulations, which limits the amount of organic solvents that can be used in antifouling paints. The most common application methods for antifouling coatings are airless spray, brush or roller. It is important that the paint can be applied by standard techniques which in turn means coating compositions and paints having a certain viscosity level, whilst minimising their VOC content and still achieving satisfactory application properties. The VOC limits may be exceeded if additional solvent must be added to reduce the viscosity at the point of application.

One solution for achieving VOC compliant and more sustainable antifouling paints is to use waterborne technology. The waterborne market will likely increase to offer more sustainable coatings to meet VOC/HAP regulations. Water-based paints have gained popularity in the interior market due to low odour, easier clean-up, faster drying and that it is healthier for staff. The advances in newer technology leads to performance and durability of waterborne coatings being closer to solvent-borne coatings for most applications.

Waterborne coatings are described in, for example CN 110358015, CN 109575746, JP 2006193731 and CN 111393926. Furthermore, CN 110643278 discloses a water-based low-surface-energy antifouling paint for ships, however the binder is still dissolved in an organic solvent (xylene) and is not emulsified in water.

Commercial vessels are typically protected by at least one layer of anti-corrosive paint followed by a tie-coat and antifouling coating. The tie-coat is thus an additional layer mainly used to ensure good adhesion of the antifouling coating to the substrate. By developing an antifouling coating that shows good adhesion directly to the anti-corrosive layer, one can envision a “one-coat-less” system saving time and resource and achieving a more sustainable coating system as the VOC will be reduced when the number of coating layers are reduced.

It is thus an object of the invention to provide new fouling release coating compositions which address at least some of these above-mentioned issues. In addition to the above-mentioned VOC demands on the coating composition, the resulting antifouling coatings should have good application properties also at lower temperatures, low surface energy, high contact angle, and good mechanical properties, and exhibit good fouling protection. A challenge with waterborne antifouling paints compared to solvent-borne is to show good film forming behaviour at lower temperature. Ideally, the new coating will show good film formation to several different substrates including directly onto some anticorrosive primers.

The present inventors have unexpectedly found that the waterborne fouling release coating compositions of the present invention offer an attractive solution. In particular, the water-borne fouling release coating compositions of the invention surprisingly have a good adhesion to organic primers. As discussed above, traditional polysiloxane-based fouling release coatings have poor adhesion to organic primers and thus a tie-coat, which is often a hybrid between a polysiloxane-based coating and an organic coating, is needed. By being able to apply the fouling release coating directly to the organic primer the overall coating system offers the possibility for lower VOCs as one coat less is used. In addition, reducing the number of coats has the potential to save both time and money and increase the operational efficiency by simplifying the paint application process.

### SUMMARY OF INVENTION

Viewed from a first aspect, the invention provides a waterborne fouling release coating composition comprising:
(a) an aqueous polysiloxane-based binder emulsion, wherein said emulsion comprises polysiloxane-based binder droplets having an average droplet size of 4 to 1000 nm; and
(b) at least one pigment or filler;
wherein the coating composition comprises at least 10 wt % water relative to the total weight of the composition as a whole.

Viewed from another aspect, the invention provides a process for preparing a waterborne fouling release coating composition as hereinbefore defined, said process comprising the steps:
(i) Dispersing at least one pigment or filler in water to produce a dispersion; and subsequently
(ii) mixing the dispersion produced in step (i) and an aqueous polysiloxane-based binder emulsion to produce said coating composition.

Viewed from a further aspect, the invention provides a coating system comprising at least two layers A and B, where said layers A and B are adjacent and wherein layer A is an organic primer layer and wherein layer B comprises the waterborne fouling release coating composition as hereinbefore defined.

Viewed from another aspect, the invention provides a process for applying a waterborne fouling release coating composition to a substrate comprising applying, e.g. by spraying, a waterborne fouling release coating composition as hereinbefore defined to a substrate and allowing the coating composition to cure.

Viewed from yet another aspect, the invention provides a substrate coated with a cured waterborne fouling release coating composition as hereinbefore defined or a coating system as hereinbefore defined.

### Definitions

As used herein the term “fouling release composition” or “fouling release coating composition” refers to a composition which, when applied to a surface, provides a fouling release surface to which it is difficult for sea organisms to permanently stick.

As used herein, the term “waterborne composition” refers to a composition which comprises water as a solvent. Typically, water forms at least 80% of the solvent used, preferably 100% of the solvent is water.

As used herein the term “binder” or “binder system” refers to the film forming components of the composition. The polysiloxane-based binders of the fouling release composition are the main binders in the composition, i.e. they form at least 50 wt % of the binder present, such as at least 70 wt %, at least 75 wt %, at least 80 wt % or at least 90 wt %. In one preferred embodiment, the polysiloxane-based binders form 100 wt % of the binders present. As used herein, the term “binder system” does not encompass additive oils. Additive oils are not considered herein to be film-forming components.

As used herein the term “paint” refers to a composition comprising the fouling release coating composition as herein described and optionally solvent which is ready for use, e.g. for spraying. Thus, the fouling release coating composition may itself be a paint or the fouling release coating composition may be a concentrate to which solvent is added to produce a paint.

As used herein the term “polysiloxane” refers to a polymer comprising siloxane, i.e. —Si—O— repeat units.

As used herein the term “polysiloxane-based binder” refers to a binder that comprises at least 50 wt %, preferably at least 60 wt % and more preferably at least 70 wt % repeat units comprising the motif —Si—O—, based on the total weight of the polymer. Polysiloxane-based binders may comprise up to 99.99 wt % repeat units comprising the motif —Si—O—, based on the total weight of the polymer. The repeat units, —Si—O— may be connected in a single sequence or alternatively may be interrupted by non-siloxane parts, e.g. organic-based parts.

As used herein, the term emulsion refers to a fine dispersion of droplets of one liquid in another in which it is not soluble or miscible. In the context of the present invention, the emulsions may be termed “oil-in-water” emulsions, i.e. wherein the dispersed phase is an oil and the continuous phase is water. Thus, the emulsions employed in the present invention may also be termed “aqueous emulsions”, meaning that they are emulsions wherein the continuous phase (i.e. the solvent) is water. Ideally, the solvent consists of water.

As used herein the term “alkyl” refers to saturated, straight chained, branched or cyclic groups.

As used herein the term “cycloalkyl” refers to a cyclic alkyl group.

As used herein the term “alkylene” refers to a bivalent alkyl group.

As used herein the term “alkenyl” refers to unsaturated, straight chained, branched or cyclic groups.

As used herein the term “aryl” refers to a group comprising at least one aromatic ring. The term aryl encompasses fused ring systems wherein one or more aromatic ring is fused to a cycloalkyl ring. An example of an aryl group is phenyl, i.e. C₆H₅.

As used herein the term “substituted” refers to a group wherein one or more, for example up to 6, more particularly 1, 2, 3, 4, 5 or 6, of the hydrogen atoms in the group are replaced independently of each other by the corresponding number of the described substituents.

As used herein the term “arylalkyl” group refers to groups wherein the bond to the Si is via the alkyl portion.

As used herein the term “polyether” refers to a compound comprising two or more —O— linkages interrupted by alkylene units.

As used herein the terms “poly(alkylene oxide)”, “poly(oxyalkylene) and “poly(alkylene glycol)” refer to a compound comprising -alkylene-O— repeat units. Typically the alkylene is ethylene or propylene.

As used herein the term “volatile organic compound (VOC)” refers to a compound having a boiling point of 250° C. or less.

As used herein “antifouling agent” or “biocide” refers to a biologically active compound or mixture of biologically active compounds that prevents the settlement of marine organisms on a surface, and/or prevents the growth of marine organisms on a surface and/or encourages the dislodgement of marine organisms from a surface. These terms are used interchangeably.

### DETAILED DESCRIPTION OF INVENTION

This invention relates to a waterborne fouling release coating composition comprising an aqueous polysiloxane-based binder emulsion and at least one filler or pigment.

### Polysiloxane-Based Binder Emulsion

The polysiloxane-based binder emulsion comprises polysiloxane-based binder droplets having an average size of 4 to 1000 nm.

### Polysiloxane-Based Binder

The polysiloxane-based binder present in the coating compositions of the present invention comprises at least 50 wt % polysiloxane parts, preferably more than 60 wt % polysiloxane parts and still more preferably more than 70 wt % polysiloxane parts, such as 99.99 wt % polysiloxane parts or more. Typical ranges include 50-100 wt % polysiloxane parts, 60-99.99 wt % polysiloxane parts, or 70-99.99 wt % polysiloxane parts in the polysiloxane-based binder.

The polysiloxane parts are defined as repeat units comprising the motif —Si—O— based on the total weight of the polysiloxane-based binder. The wt % of polysiloxane parts can be determined based on the stoichiometric wt ratio of starting materials in the polysiloxane synthesis. Alternatively, the polysiloxane content can be determined using analytical techniques such as IR or NMR.

Typically, the wt. % of polysiloxane parts is calculated based on the molar ratio of reactive starting materials in the polysiloxane synthesis. If a molar excess of a monomer is present in the reaction mixture then such a molar excess is not counted. Only those monomers that can react based on the stoichiometry of the reaction are counted.

Information about the wt. % polysiloxane parts in a commercially available polysiloxane-based binder is easily obtainable from the supplier.

It is to be understood that the polysiloxane-based binder can consist of a single repeating sequence of siloxane units or be interrupted by non-siloxane parts, e.g. organic parts. It is preferred if the polysiloxane-based binder contains only Si—O repeating units.

The organic parts may comprise, for example, alkylene, arylene, poly(alkylene oxide), amide, thioether or combinations thereof, preferably the organic parts may comprise, for example, alkylene, arylene, poly(alkylene oxide), amide, or combinations thereof

By curable means that the polysiloxane-based binder comprises functional groups that enable a crosslinking reaction to take place either between polysiloxane-based binder molecules or via a crosslinking agent.

The polysiloxane-based binder is preferably an organopolysiloxane with terminal and/or pendant curing-reactive functional groups. A minimum of two curing-reactive functional groups per molecule is preferred. Examples of curing-reactive functional groups are silanol, alkoxy, acetoxy, enoxy, ketoxime alcohol, amineoxy, amine, epoxy, vinyl and/or isocyanate. A preferred polysiloxane-based binder contains curing-reactive functional groups selected from silanol, alkoxy or acetoxy groups. The curing reaction is typically a condensation cure reaction. The polysiloxane-based binder optionally comprises more than one type of curing-reactive group and may be cured, for example, via both condensation cure and amine/epoxy curing.

The polysiloxane-based binder may be a linear or branched polysiloxane-based binder. By branched is meant that the polysiloxane chain is branched. The branched polysiloxane-based binder may also comprise cage-like polysiloxane structures also known as polysiloxane resins.

In one preferred embodiment the polysiloxane-based binder is linear.

The polysiloxane-based binder may be modified by hydrophilic groups to aid the process of emulsifying the binders in water. Examples of suitable hydrophilic groups may be ethers (e.g. polyoxyalkylene groups such as polyethylene glycol and polypropylene glycol), alcohols (e.g. poly(glycerol)), amides (e.g. pyrroliodone, polyvinylpyrrolidone, (meth)acrylamide), acids (e.g. carboxylic acids, poly(meth)acrylic acid), amines and polyamines (e.g. polyvinylamine, (meth)acrylic polymers comprising amine groups).

In one preferred embodiment the polysiloxane-based binder has been modified by amine, polyamine or polyether groups.

Preferably the polysiloxane-based binder is not modified.

A preferred polysiloxane-based binder present in the fouling release coating compositions of the present invention is represented by formula (I) below:

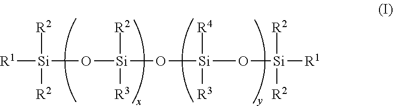

wherein
each R¹ is independently selected from a hydroxyl group, C₁₋₆-alkoxy group, C₁₋₆-hydroxyl group, C₁₋₆-epoxy containing group, C₁₋₆ amine group, C₁₋₁₀ alkyl group, C₆₋₁₀ aryl, C₇₋₁₀ alkaryl or O—Si(R⁵)_{3-z}(R⁶)_{z}
each R² is independently selected from C₁₋₁₀ alkyl, C₆₋₁₀ aryl, C₇₋₁₀ alkylaryl or C₁₋₆ alkyl substituted by poly(alkylene oxide) and/or a group as described for R¹;
each R³ and R⁴ is independently selected from C₁₋₁₀ alkyl, C₆₋₁₀ aryl, C₇₋₁₀ alkylaryl or C₁₋₆ alkyl substituted by poly(alkylene oxide);
each R⁵ is independently a hydrolysable group such as C₁₋₆ alkoxy group, an acetoxy group, an enoxy group or ketoxy group;
each R⁶ is independently selected from a C₁₋₆ alkyl group;
z is 0 or an integer from 1-2;
x is an integer of at least 2;
y is an integer of at least 2.

Preferably R¹ is selected from a hydroxyl group and O—Si(R⁵)_{3-z}(R⁶)_{z}, wherein R⁵ is a C₁-C₆ alkoxy group, R⁶ is C₁₋₆ alkyl and z is 0 or an integer from 1-2. More preferably R¹ is selected from a hydroxyl group and O—Si(R⁵)_{3-z}(R⁶)_{z}, wherein R⁵ is a C₁-C₃ alkoxy group, R⁶ is C₁₋₃ alkyl and z is 0 or an integer from 1-2.

Preferably R² is a C₁₋₁₀ alkyl group, C₆₋₁₀ aryl, C₇₋₁₀ alkylaryl or O—Si(R⁵)_{3-z} (R⁶)_{z}. More preferably R² is a C₁₋₄ alkyl group, still more preferably a C₁₋₂ alkyl group, and yet more preferably a methyl group. Preferably each R² is the same.

Preferably R³ is a C₁₋₁₀ alkyl group. More preferably R³ is a C₁₋₄ alkyl group, still more preferably a C₁₋₂ alkyl group, and yet more preferably a methyl group. Preferably each R³ is the same.

Preferably R⁴ is a C₁₋₁₀ alkyl group. More preferably R⁴ is a C₁₋₄ alkyl group, still more preferably a C₁₋₂ alkyl group, and yet more preferably a methyl group. Preferably each R⁴ is the same.

Still more preferably R¹ is a hydroxyl group and R², R³ and R⁴ are each methyl groups.

Another preferred polysiloxane-based binder present in the fouling release coating compositions of the present invention is represented by formula (II) below:

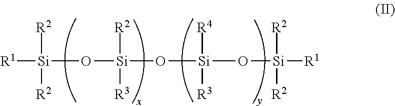

wherein
each R¹ is independently selected from a hydroxyl group, C₁₋₆-alkoxy group or O—Si(R⁵)_{3-z}(R⁶)_{z}
each R² to R⁴ are methyl;
each R⁵ is independently a hydrolysable group such as C₁₋₆ alkoxy group, an acetoxy group, an enoxy group or ketoxy group;
each R⁶ is independently selected from a C₁₋₆ alkyl group;
z is 0 or an integer from 1-2;
x is an integer of at least 2;
y is an integer of at least 2.

Another preferred polysiloxane-based binder present in the fouling release coating compositions of the present invention is represented by formula (III) below:

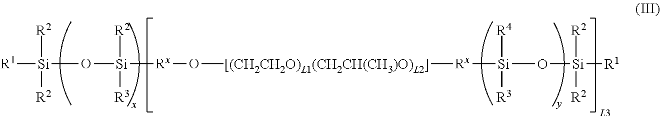

wherein R¹, R², R³, R⁴ and x and y are as defined for (I), RX is C₂₋₃ alkyl, each L1 is 0 to 50, each L2 is 0 to 50 with the proviso that L1+L2 is 2 to 50, preferably 4 to 40, more preferably 4-20, most preferably 4-10 and L3 is 1-200, preferably 2-100, most preferably 5-50. The polysiloxane parts must form a minimum of 50 wt % of the molecule.

Preferably the polysiloxane-based binder of the present invention is represented by formula (I). Most preferably, the polysiloxane-based binder is a polydimethylsiloxane.

The skilled person will be aware that the polysiloxane-based binder may contain low amounts of impurities, such as cyclic siloxanes, that are residues from polysiloxane synthesis. From a health, safety, and environmental aspect, it is preferred to limit the amount of cyclic polysiloxanes present in the coating. In one preferred embodiment the polysiloxane-based binder contains less than 5% of cyclic polysiloxanes, preferable less than 2%, more preferably less than 1%. In one particularly preferred embodiment, the polysiloxane-based binder is free of cyclic polysiloxanes.

The weight average molecular weight of the polysiloxane-based binder is preferably 400-150 000, more preferably 1000 to 140 000, further preferred 5000-130 000 especially 10 000 to 120 000 g/mol.

The number average Mw of the polysiloxane-based binder is preferably 400 to 100 000 g/mol, more preferably 1000-80,000 g/mol, still more preferably 2000-70 000 g/mol, especially 5000-60 000 g/mol.

Alternatively viewed, the viscosity of the polysiloxane-based binder is preferably 100 to 50 000 mPas, preferably 200 to 40 000 mPas, especially 400 to 30 000 mPas.

It will be understood that the polysiloxane-based binder droplets form the dispersed phase of the emulsion.

The polysiloxane-based binder is present in the emulsion in the form of droplets with an average size of 4 to 1000 nm, preferably 25 to 400 nm, more preferably 50 to 350 nm, such as 100 to 300 nm, when measured by dynamic light scattering at room temperature. The “average size” referred to in this context is the Z-average size, which will be understood to be the intensity weighted mean size.

The amount of polysiloxane-based binder in the coating composition is preferably 10-90 wt. %, more preferred 15-70 wt. %, further preferred 20-60 wt. % of the total weight of the coating composition.

The amount of polysiloxane-based binder in the coating composition is preferably 15-95 wt. %, more preferred 20-90 wt. %, further preferred 30-80 wt. % of the total dry weight of the coating composition.

### Emulsion

In addition to the polysiloxane-based binder droplets, the emulsion comprises aqueous solvent (i.e. the continuous phase). It will be understood that an aqueous solvent is one comprising (preferably consisting of) water.

Thus, in a particularly preferred embodiment, the emulsion consists of the polysiloxane-based binder droplets and water.

The polysiloxane-based binder droplets ideally form 30 to 90 wt % of the emulsion, relative to the total weight of the emulsion as a whole. Typical wt % ranges may be 35 to 80 wt %, such as 40 to 70 wt %, relative to the total weight of the emulsion as a whole.

The solvent (preferably water) forms 10 to 70 wt % of the emulsion, relative to the total weight of the emulsion as a whole. Typical wt % ranges may be 20 to 65 wt %, such as 30 to 60 wt %, relative to the total weight of the emulsion as a whole.

The emulsion may be prepared by any suitable known method in the art.

The emulsion may comprise emulsifying agents. The emulsifying agent may be non-ionic, anionic, cationic or amphoteric.

Examples of non-ionic emulsifiers are alkyl phenoxy ethers, polyalkylene glycols, polyoxyalkylene sorbitan monooelates, polyvinyl alcohols, polyvinyl esters, polyether siloxanes and sorbitan stearates. Preferred non-ionic emulsifying agents are polyalkylene glycols such as polyoxyethylene-polyoxypropylene co-polymers.

Examples of anionic emulsifying agents are alkyl-, aryl-, alkaryl- sulphates, sulphonates, phosphates, sulpho-succinates, sulphosuccinamates, sulphoacetates and amino acid derivatives.

Particularly preferred anionic emulsifying agents are alkylbenzenesulfonate salts, alkyl ether sulfate salts, polyoxyethylene alkyl ether sulfate salts, polyoxyethylene alkylphenyl ether sulfate salts, alkylnaphthylsulfonate salts, unsaturated aliphatic sulfonate salts, and hydroxylated aliphatic sulfonate salts. The alkyl group referenced here can be exemplified by medium and higher alkyl groups such as decyl, undecyl, dodecyl, tridecyl, tetradecyl, cetyl, stearyl, and so forth. The unsaturated aliphatic group can be exemplified by oleyl, nonenyl, and octynyl. The counterion can be exemplified by sodium ion, potassium ion, lithium ion, and ammonium ion, with the sodium ion being typically used among these.

The cationic emulsifying agent can be exemplified by quaternary ammonium salt-type surfactants such as alkyltrimethylammonium salts, e.g., octadecyltrimethylammonium chloride and hexadecyltrimethylammonium chloride, and dialkyldimethylammonium salts, e.g., dioctadecyldimethylammonium chloride, dihexadecyldimethylammonium chloride and didecyldimethylammonium chloride.

The amphoteric surfactant can be exemplified by alkylbetaines and alkylimidazolines.

The emulsions may also comprise crosslinkers, curing catalysts, antifoaming agents, preservatives, pH adjusting agents and buffers.

Example of suitable commercially available emulsions include Coatosil DRI from Momentive, Dowsil 8005 and Dowsil 8016 from Dow and Powersil 577 Plus from Wacker.

The emulsion preferably forms 50 to 90 wt % of the fouling release coating composition, relative to the total weight of the composition as a whole. Typical wt % ranges may be 55 to 85 wt %, such as 60 to 80 wt %, relative to the total weight of the composition as a whole.

Crosslinking and/or Curing Agent

The polysiloxane-based binder of the present invention is curable and contains curing-reactive functional groups such as silanol, alkoxysilane, ketoxime, carbinol, amine, epoxy and/or alkoxy groups.

Preferably the polysiloxane-based binder contains at least two curing-reactive functional groups. Optionally the polysiloxane-based binder comprises more than one type of curing-reactive functional group. Preferably the polysiloxane-based binder comprises a single type of curing-reactive functional group. The appropriate crosslinking and/or curing agents are chosen depending on the curing-reactive functional groups present in the polysiloxane-based binder.

In preferred polysiloxane-based binders the curing-reactive functional groups are silanol, or alkoxysilane. In still further preferred polysiloxane-based binders the curing-reactive functional groups are silanol.

It may be necessary to add a crosslinker to obtain the desired crosslinking density. The crosslinker may be added separately to the coating composition or the crosslinker may be part of the polysiloxane-based binder emulsion. Preferably the crosslinker is part of the polysiloxane-based binder emulsion.

If the curing-reactive functional groups are silanol, a preferred crosslinking agent is an organosilicon compound represented by the general formula shown below, a partial hydrolysis-condensation product thereof, or a mixture of the two:

R_{d}−Si−K_{4-d}
wherein,
each R is independently selected from a monovalent hydrocarbon group of 1 to 6 carbon atoms, C₁₋₆ alkyl substituted by poly(alkylene oxide) or a polysiloxane of the
structure (O—(CR^{D}₂)_{r′})_{r1′}—(O—(CR^{D}₂)_{s′})_{s1′}—(Si(R^{PP})₂—O)_{t′}—Si(R^{PP})₃; wherein r′, r1′, s′ and s1′ is an integer from 0-10, each R^{D} is independently selected from H or C₁₋₄ alkyl, each R^{PP} is independently selected from C₁₋₁₀ alkyl, C₆₋₁₀ aryl, C₇₋₁₀ alkylaryl and t′ is an integer from 1 to 50;
each K is independently selected from a hydrolysable group such as an alkoxy group; and d is 0, 1 or 2, more preferably 0 or 1.

Preferred crosslinkers of this type include tetraethoxysilane, vinyltris(methylethyloximo)silane, methyltris(methylethyloximo)silane, vinyltrimethoxysilane, methyltrimethoxysilane and vinyltriisopropenoxysilane as well as hydrolysis-condensation products thereof.

If the curing-reactive functional groups are di or tri-alkoxy, a separate crosslinking agent is generally not required.

The crosslinking agent is preferably present in amount of 0-10 wt % of the total dry weight of the coating composition, preferably 2.0 to 8.0 wt %. Suitable crosslinking agents are commercially available, such as Silicate TES-40 WN from Wacker and Dynasylan A from Evonik.

If the curing-reactive functional groups are carbinol, preferred curing agents are monomeric isocyanates, polymeric isocyanates and isocyanate prepolymers. Polyisocyanates are preferred over monomeric isocyanates because of lower toxicity. Polyisocyanates can for example be based on diphenylmethane diisocyanate (MDI), toluene diisocyanate (TDI), hexamethylene diisocyanate (HDI) and isophorone diisocyanate (IPDI) chemistry. These are, for example, supplied under the tradename Desmodur by Covestro and Tolonate by Vencorex. Examples of polyisocyanates are Desmodur N3300, Desmodur 3390 BA/SN, Desmodur N3400, Desmodur N3600 Desmodur N75, Desmodur XP2580, Desmodur Z4470, Desmodur XP2565 and Desmodur VL, supplied by Covestro.

Polyisocyanates can be made with different NCO-functionality. The NCO-functionality is the amount of NCO-groups per polyisocyanate molecule or isocyanate prepolymer molecule. Polyisocyanates curing agents with different NCO-functionality can be used.

The curing agent is preferably present in an amount of 0.8-2.5 equivalents (equiv) NCO groups relative the amount of hydroxyl groups, preferably 0.9-2.0 equiv, more preferably 0.95-1.7 equiv, even more preferably 1-1.5 equiv.

If the curing-reactive functional groups are amine, epoxy or isocyanate, the curing agents are preferably amine, sulfur or epoxy functional.

The curing agents can also be dual curing agents containing, for example, both amine/sulphur/epoxy/isocyanate and an alkoxysilane. Preferred dual curing agents are represented by the general formula below:

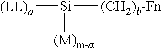

wherein
LL is independently selected from an unsubstituted or substituted monovalent hydrocarbon group of 1 to 6 carbon atoms;
each M is independently selected from a hydrolysable group such as an alkoxy group;
a is 0, 1 or 2, preferably 0 or 1;
b an integer from 1 to 6; and
Fn is an amine, epoxy, glycidyl ether, isocyanate or sulphur group.

Preferred examples of such dual curing agents include 3-isocyanatopropyltrimethoxysilane, 3-isocyanatopropyltriethoxysilane, 3-aminopropyltrimethoxysilane, 3-aminopropyltriethoxysilane, (3-glycidoxypropyl)trimethoxysilane, 3-mercaptopropyltrimethoxysilane. One particularly preferred curing agent is 3-aminopropyltriethyoxysilane such as Dynasylan AMEO from Evonik.

This type of dual-curing agents can be used as a separate curing agent or be used to end-cap the polysiloxane-based binder so that the end-groups of the polysiloxane-based binder are modified prior to the curing reaction.

### Catalyst Component

In order to assist the curing process, the coating composition of the invention may comprise a catalyst component. The catalyst can be organic or inorganic or an organometallic catalyst. The catalyst component may be part of the polysiloxane-based binder emulsion or it may be added separately to the coating composition. Preferably, if present the curing catalyst is part of the polysiloxane-based binder emulsion.

### Metal Catalyst

In one embodiment, the coating composition of the invention comprises a metal catalyst. Representative examples of catalysts that can be used include Sn, Zn, Li, K, Bi, Fe, Ce or Zr containing catalysts, e.g. salts and organometallic complexes thereof. The salts preferably are salts of long-chain carboxylic acids and/or chelates or organometal salts.

The metal catalysts are preferably tin (IV), bismuth(III), iron(II), iron(III), zinc(II), zirconium(IV), cerium (III), potassium or lithium compounds. Tin (IV), bismuth (III), zinc (II) and lithium being particularly preferred.

Examples of anionic organic radicals include methoxide, ethoxide, n-propoxide, isopropoxide, n-butoxide, isobutoxide, sec-butoxide, tert-butoxide, triethanolaminate, and 2-ethylhexyloxide radicals; carboxylate radicals such as the acetate, formate, n-octoate, 2-ethylhexanoate, 2,4,4-trimethylpentanoate, 2,2,4-trimethylpentanoate, 6-methylheptanoate, oleate, ricinoleate, palmitate, hexoate, hexadecanate, 2-ethylhexanoate, benzoate, 1,4-dibenzoate, stearate, acrylate, laurate, methacrylate, 2-carboxyethylacrylate, oxalate, 10-undecylenate, dodecanoate, citrate, 3-oxopentanoate, 3-oxobutanoate, and neodecanoate radicals; amide radicals such as the dimethylamide, diethylamide, ethylmethylamide, and dipropylamide radicals; the lactate radical; trialkylsiloxy radicals, more particularly trimethylsiloxy and triethylsiloxy radicals, and also carbonate radicals (O—CO—OR′) and carbamate radicals (O—CO—NR′₂), where R′ may be identical or different and are monovalent or divalent, optionally substituted hydrocarbon radicals and, furthermore, may be hydrogen, trimethoxysilylpropyl, triethoxysilylpropyl, dimethoxymethylsilylpropyl, diethoxymethylsilylpropyl, N-[3-(trimethoxysilyl)propyl]-2-aminoethyl, N-[3-(triethoxysilyl)propyl]-2-aminoethyl, N-[3-(dimethoxymethylsilyl)propyl]-2-aminoethyl or N-[3-(diethoxymethylsilyl)propyl]-2-aminoethyl radicals.

Examples of metal salt compounds are dibutyltin diacetate, dioctyltin dilaurate, dibutyltin dilaurate, dibutyltin oxide, bismuth(III) 2-ethylhexanoate, bismuth(III) neodecanoate, bismuth(III) acetate, bismuth (III) octanoate, iron(II) acetate, iron(III) tert-butoxide, iron(III) citrate, iron(II) lactate, iron(II) oxalate, iron(III) oxalate, iron(III) 2-ethylhexanoate, zinc(II) acetate, zinc(II) formate, zinc(II) benzoate, zinc(II) 2-ethylhexanoate, cerium (III) neodecanoate, zinc(II) n-octoate, zinc(II) stearate, zinc(II) ethoxide, zinc(II) acrylate, zinc(II) methacrylate, zinc (II) naphthenate, zinc(II) oxalate, zinc(II) 10-undecylenate, zinc(II) 3-oxopentanoate, zinc(II) 3-oxobutanoate, zirconium(IV) acetate, zirconium(IV) 2-ethylhexanoate, zirconium(IV) lactate, zirconium(IV) n-butoxide, zirconium(IV) tert-butoxide, zirconium(IV) isopropoxide, zirconium(IV) n-propoxide, zirconium(IV) 2-carboxyethylacrylate, zirconium(IV) tetrakis(diethylamide), zirconium(IV) tetrakis(ethylmethylamido), zirconium(IV) bis(diethylcitrate)-di-n-propoxide.

Examples of metal chelate compounds bismuth(III) 2,2,6,6-tetramethyl-3,5-heptanedionate, bismuth(III) acetylacetonate, iron(II) acetylacetonate, iron(III) acetylacetonate, iron(III) 2,2,6,6-tetramethyl-3,5-heptanedionate, iron(II) 2,2,6,6-tetramethyl-3,5-heptanedionate, zinc(II) hexafluoroacetylacetonate, zinc(II) 1,3-diphenyl-1,3-propanedionate, zinc(II) 1-phenyl-5-methyl-1,3-hexanedionate, zinc(II) 1,3-cyclohexanedionate, zinc(II) 2-acetylcyclohexanonate, zinc(II) 2-acetyl-1,3-cyclohexanedionate, zinc(II) ethylsalicylate, zinc(II) diethylmalonate, zinc(II) ethylacetoacetate, zinc(II) benzylsalicylate, zinc(II) acetylacetonate, and zinc(II) 2,2,6,6-tetramethyl-3,5-heptanedionate, tin(II) acetylacetonate, zirconium(IV) acetylacetonate, zirconium(IV) 2,2,6,6-tetramethyl-3,5-heptanedionate, zirconium(IV) trifluoroacetylacetonate, and zirconium(IV) hexafluoroacetylacetonate.

Examples of suitable tin catalysts are dibutyltin dilaurate, dibutyltin dioctoate, dibutyltin diacetate, dioctyltin dilaurate. Examples of commercially available tin catalysts include BNT-CAT 400 and BNT-CAT 500 from BNT Chemicals, FASCAT 4202 from PMC Organometallix and Metatin Katalysator 702 from DOW.

Examples of suitable lithium catalysts are lithium 2-ethylhexanoate and lithium neodecanoate. Example of commercially available lithium catalyst includes Borchers Deca Lithium 2 manufactured by Borchers.

Examples of suitable potassium catalysts are potassium 2-ethylhexanoate and potassium neodecanoate. Examples of commercially available potassium catalysts include 15% Potassium Hex-Cem® EU manufactured by Borchers and TIB KAT K30 from TIB Chemicals.

Examples of suitable zinc catalysts are zinc 2-ethylhexanoate, zinc naphthenate and zinc stearate. Examples of commercially available zinc catalysts include K-KAT XK-672 and K-KAT670 from King Industries and Borchi Kat 22 from Borchers.

Examples of suitable bismuth catalysts are organobismuth compounds such as bismuth 2-ethylhexanoate, bismuth octanoate and bismuth neodecanoate. Examples of commercial organobismuth catalysts are Borchi Kat 24 and Borchi Kat 315 from Borchers. K-KAT XK-651 from King Industries, Reaxis C739E50 from Reaxis and TIB KAT 716 from TIB Chemicals.

Example of suitable cerium catalyst is cerium (III) neodecanoate.

Other suitable catalysts are iron catalysts such as iron stearate and iron 2-ethylhexanoate, and zirconium catalysts such as zirconium naphthenate, tetrabutyl zirconate, tetrakis(2-ethylhexyl) zirconate, triethanolamine zirconate, tetra(isopropenyloxy)-zirconate, zirconium tetrabutanolate, zirconium tetrapropanolate and zirconium tetraisopropanolate. Further suitable catalysts are zirconate esters.

In one preferred embodiment the metal catalyst is a tin, zinc and/or cerium catalyst.

In one preferred embodiment the catalyst is tin free.

Preferably the metal catalyst is present in the coating composition of the invention in an amount of 0.05 to 5.0 wt % based on the total dry weight of the coating composition, more preferably 0.1 to 2.0 wt %.

### Organic Catalysts

The catalyst may also be organic, such as a low molecular weight amidine or a low molecular weight amine compound such as an aminosilane. The term low molecular weight means that its molecular weight is less than 1000 g/mol, such as 50 to 500 g/mol, preferably 100 to 400 g/mol.

Suitable amidines are compounds comprising the motif:

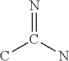

Preferably the amidine is represented by the following general formula:

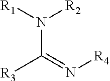

wherein R₁, R₂, R₄ are each independently selected from hydrogen, monovalent organic groups, monovalent heteroorganic groups, and combinations thereof;
R₃ is a monovalent organic group, monovalent heteroorganic groups, and combinations thereof:
and/or wherein any two or more of R¹, R², R³, R⁴ optionally can be bonded together to form a ring structure.
R₁, R² and R⁴ are preferably hydrogen or C1-6 alkyl or phenyl groups.
R³ is C₁₋₆ alkyl or phenyl groups.

Still more preferably R²+R⁴ taken together form a ring and/or R¹+R₃ taken together form a ring. Such rings are preferably aliphatic 5-7 membered rings.

Preferred options include cyclic amidines, preferably bicyclic amidines such as 1,8-diazabicyclo-5.4.0-7-undecene (DBU)). The chemical structure of DBU is presented below:

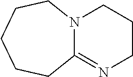 [SMILES: C1CCC2=NCCCN2CC1]

The catalyst may also be a low molecular weight organic amine compound, such as triethylamine, a cyclic amine, tetramethylethylenediamine, 1,4-ethylenepiperazine and pentamethyldiethylenetriamine.

Preferred amines are however aminosilanes such as aminoalkyltrialkoxysilane such as 3-aminopropyltriethoxysilane or 3-aminopropyltrimethoxy silane, or bis(alkyltrialkoxysilyl)amine preferably comprises bis(3-propyltrimethoxysilyl)amine or bis(3-propyltriethoxysilyl)amine. Another option is N,N-dibutylaminomethyl-triethoxysilane.

Suitable aminosilanes are of general formula (IV) or (V)

Y—R_{(4-z)}SiX_{z} (IV)
wherein z is an integer from 1 to 3,

Y—R_{(3-y)}R¹SiX_{y} (V)
wherein y is an integer from 1 to 2,
each R is a hydrocarbyl group having 1 to 12 C atoms optionally containing an ether or amino linker,
R¹ is a hydrocarbyl group having 1 to 12 C atoms;
each X independently represents an alkoxy group.
Y is an amino bound to R.

The Y group can bind to any part of the chain R.

The amino groups are preferably N-di-C1-6-alkyl or NH₂.

It is especially preferred if X is a C1-6 alkoxy group, especially methoxy or ethoxy group. It is also especially preferred if there are two or three alkoxy groups present. Thus, z is ideally 2 or 3, especially 3.

Subscript y is preferably 2.

R¹ is preferably C1-4 alkyl such as methyl.

R is a hydrocarbyl group having up to 12 carbon atoms. By hydrocarbyl is meant a group comprising C and H atoms only. It may comprise an alkylene chain or a combination of an alkylene chain and rings such as phenyl or cyclohexyl rings. The term “optionally containing an ether or amino linker” implies that the carbon chain can be interrupted by a —O— or —NH— group in the chain.
R is preferably an unsubstituted (other than Y obviously), unbranched alkyl chain having 2 to 8 C atoms.

A preferred silane general formula is therefore of structure (VI)

Y′—R′_{(4-z′)}SiX′_{z} (VI)
wherein z′ is an integer from 2 to 3,
R′ is an unsubstituted, unbranched alkyl chain having 2 to 8 C atoms
optionally containing an ether or amino linker,
Y′ is an amino functional group bound to the R′ group, and
X′ represents an alkoxy group.

Examples of such silanes are the many representatives of the products manufactured by Degussa in Rheinfelden and marketed under the brand name of Dynasylan®D, the Silquest® silanes manufactured by Momentive, and the GENOSIL® silanes manufactured by Wacker.

Preferred aminosilanes include aminopropyltrimethoxysilane (Dynasylan AMMO; Silquest A-1110), aminopropyltriethoxysilane (Dynasylan AMEO) or N-(2-aminoethyl)-3-aminopropyltrimethoxysilane (Dynasylan DAMO, Silquest A-1 120), N-(2-aminoethyl)-3-aminopropyltriethoxysilane, triamino-functional trimethoxysilane (Silquest A-1130), bis(gamma-trimethoxysilylpropyl)amine (Silquest A-1170), N-ethyl-gamma-aminoisobytyltrimethoxy silane (Silquest A-Link 15), N-phenyl-gamma-aminopropyltrimethoxysilane (Silquest Y-9669), 4-amino-3,3-dimethylbutyltrimethoxysilane (Silquest Y-11637), (N-cyclohexylaminomethyl)triethoxysilane (Genosil XL 926), (N-phenylaminomethyl)trimethoxysilane (Genosil XL 973), and mixtures thereof.

Other specific silanes of interest include 3-Aminopropyltriethoxysilane, 3-Aminopropyltrimethoxysilane, N-(Aminoethyl)-aminopropyltrimethoxysilane H₂NCH₂CH₂NHCH₂CH₂CH₂Si(OCH₃)₃, 3-aminopropylmethyldiethoxysilane, 3-(2-aminoethylamino)propylmethyldimethoxysilane (H₂NCH₂CH₂NHCH₂CH₂CH₂SiCH₃(OCH₃)₂).

It should be understood that the amino silane may act both as a catalyst and as a crosslinking agent due to the silane group being able to react with the polysiloxane-based binder if the binder comprises silicone reactive groups such as Si—OH groups, Si—OR (alkoxy) groups etc.

The amount of organic catalyst present in the coating composition may be 0.05 to 5.0 wt %, preferably 0.1 to 4.0 wt. %, such as 0.1 to 2.0 wt. %, more preferred 0.1 to 1.0 wt. % of the coating composition (dry weight).

### Additive Oils

The coating compositions of the invention may comprise additive oils. These additive oils do not comprise any curing reactive groups, hence the additive oils are intended to be non-reactive in the curing reaction. Depending on the curing mechanism for the binder system the functional groups on the additive oils should be chosen so that they do not react in the curing reaction of the polysiloxane-based binder. The additive oils are intended to be free in the coating film so that they can migrate to the surface of the coating film and improve the antifouling properties of the coating film.

Examples of Suitable Additive Oils are Hydrophilic Modified Polysiloxane Oils and hydrophobic modified polysiloxane oils. Other additive oils may also be used such as petroleum oils, polyolefin oils, polyaromatic oils, fluoro resins such as polytetra-fluoroethylene or fluid fluorinated alkyl- or alkoxy-containing polymers, or lanolin and lanolin derivatives and other sterol(s) and/or sterol derivative(s) as disclosed in WO2013024106A1, or poly(oxyalkylene) modified alcohols such as poly(oxy alkylene) modified sterols as disclosed in WO2016004961 A1 or combinations thereof.

A further additive oil optionally present in the coating compositions of the invention is fluorinated amphiphilic polymers/oligomers as described in WO2014131695.

A suitable additive oil may also be based on methacrylate co-polymers having polysiloxane side chains and polyether or nitrogen containing hydrophilic groups such as described in WO2019101912 A1 and WO2019101920 A1.

Preferably the additive oil is a hydrophilic modified polysiloxane oil and/or a hydrophobic modified polysiloxane oil. The hydrophilic modified polysiloxane oils and the hydrophobic modified polysiloxane oil may be used in combination. Suitable hydrophilic modified polysiloxane oils and hydrophobic modified polysiloxane oils are described in more detail below.

### Hydrophilic Modified Polysiloxane Oil

The coating composition of the invention may additionally comprise a hydrophilic modified polysiloxane. It will be appreciated that this component is different from the polysiloxane-based binder discussed above.

It should be understood that the hydrophilic modified polysiloxane does not contain curing reactive groups such as Si—OH groups, Si—OR (alkoxy) groups etc. that can react with the binder at relevant curing temperatures (0-40° C.), hence the hydrophilic-modified polysiloxane is intended to be non-reactive in the curing reaction, in particular with respect to the binder components. Generally, this component is not regarded as part of the binder system. The functional groups on the hydrophilic modified polysiloxane should be chosen so that, depending on the curing mechanism, they do not react in the curing reaction.

Preferably the hydrophilic modified polysiloxane does not contain silicone reactive groups such as Si—OH groups, Si—OR (alkoxy) groups etc. that can react with the binder at relevant curing temperatures (0-40° C.).

Hydrophilic-modified polysiloxanes are widely used as surfactants and emulsifiers due to the content of both hydrophilic and lipophilic groups in the same molecule. A hydrophilic modified polysiloxane according to the present invention is a polysiloxane that is modified with hydrophilic groups to make it more hydrophilic compared to the corresponding unsubstituted polysiloxane having the same number of polysiloxane units. The skilled person will appreciate that by “hydrophilic” we mean a substance or group which has an affinity for water. The hydrophilicity can be obtained by modification with hydrophilic groups such as ethers (e.g. polyoxyalkylene groups such as polyethylene glycol and polypropylene glycol), alcohols (e.g. poly(glycerol), amides (e.g. pyrroliodone, polyvinylpyrrolidone, (meth)acrylamide) acids (e.g. carboxylic acids, poly(meth)acrylic acid), amines (e.g. polyvinylamine, (meth)acrylic polymers comprising amine groups). Typically, the hydrophilic-modified polysiloxane is an oil.

In one preferred embodiment the hydrophilic groups are non-ionic.

‘Non-ionic’ herein means that the hydrophilic-modified polysiloxane does not contain any salt moieties; in particular, it typically does not contain any metal cations.

The hydrophilicity of non-ionic hydrophilic modified polysiloxanes can be determined in accordance with the HLB (hydrophilic-lipophilic balance) parameter. If the hydrophilic modified polysiloxane of the present invention is non-ionic, the HLB (hydrophilic-lipophilic balance) is in the range 1-12, preferably 1.0-10, more preferably 1.0-8.0, most preferably 2.0-7.0. In a particular embodiment, the non-ionic hydrophilic modified polysiloxane has an HLB in the range 3.0-6.0.

The HLB is herein typically determined according to Griffin's model using the equation “wt % hydrophilic groups”/5 (Reference: Griffin, W. C. Calculation of HLB values of non-ionic surfactants, J. Soc. Cosmet. Chem. 1954, 5, 249-256). The HLB parameter is a well-established parameter for non-ionic surfactants and is readily available from the suppliers of commercially available hydrophilic modified polysiloxanes. The higher surfactant HLB value, the more hydrophilic it is. By wt % hydrophilic groups means the wt % of hydrophilic groups in the hydrophilic modified polysiloxane.

One function of the hydrophilic modified polysiloxane is to facilitate the dissolution and transport of any biocide to the surface of the coating film. In addition, it is also well known that formation of a hydrated layer at the coating-water interphase is important for the fouling protection performance.

If the hydrophilicity of the hydrophilic modified polysiloxane is too high, for example due to a high amount of hydrophilic groups in the molecule, this could lead to an early depletion of the biocide(s) and the hydrophilic modified polysiloxane due to a too high leaching rate. A high hydrophilicity will also give poor compatibility with the polysiloxane based binder matrix, especially if high oil amounts (more than 10 wt. %) are used, giving poor film homogeneity and poor adhesion.

The ways to control the leach rate of the biocide and the hydrophilic modified polysiloxane include the molecular weight of the hydrophilic modified polysiloxane, the hydrophilicity and the miscibility with the binder. A very low molecular weight hydrophilic modified polysiloxane tends to allow a high leach rate, while too high molecular weight may not allow the leaching of the biocide and the hydrophilic modified polysiloxane to be of the desired rate.

Hence, in a preferred embodiment, the hydrophilic modified polysiloxane has a number average molecular weight (Mn) in the range of 500-18,000 g/mol, such as in the range of 1000-16,000 g/mol, particularly in the ranges 2000-15,050 g/mol or 4000-15,050 g/mol. Further suitable Mn ranges for the hydrophilic modified polysiloxane include 500-15,000 g/mol, 1,000-13,000 g/mol or 3,000-10,000 g/mol. Number average molecular weight (Mn) values referred to herein correspond to the experimentally obtained values, e.g. by GPC measured relative to a polystyrene standard. The method is given in the experimental section below.

In a preferred embodiment, the hydrophilic modified polysiloxane has a weight average molecular weight (Mw) of 1,000-50,000 g/mol, preferably in the ranges of 2,000-45,000 g/mol, 3,000-42,000 g/mol, 4,000-40,000 g/mol, or 5,000-40,000 g/mol. Further suitable ranges include 5,000-30,000 g/mol, e.g. 5,000-25,000 g/mol or 10,000-20,000 g/mol. Weight average molecular weight (Mw) values referred to herein correspond to the experimentally obtained values, e.g. by GPC measured relative to a polystyrene standard.

It is also preferred if the hydrophilic modified polysiloxane has a viscosity in the range of 20-4,000 mPa-s, such as in the range of 30-3,000 mPa-s, in particular in the range of 50-2,500 mPa-s.

Of particular interest are those hydrophilic-modified polysiloxanes in which the relative weight of the hydrophilic moieties is 5% or more of the total weight (e.g. 5-60%), such as 6% or more (e.g. 6-50%), in particular 10% or more (e.g. 10-40%) of the total weight of the hydrophilic-modified polysiloxane.

The wt. % of the hydrophilic moieties can be calculated based on the stoichiometric ratio of starting materials in the hydrophilic modified polysiloxane synthesis, or it can be determined using analytical techniques such as IR or NMR.

If there is a molar excess of a reactant then such a molar excess is not counted when determining the wt. % of hydrophilic moieties. Only those monomers that can react based on the stoichiometry of the reaction are counted.

The hydrophilic modified polysiloxane may contain low amounts of impurities, such as cyclic siloxanes, such as D4, D5 and D6 cyclosiloxanes, that are residues from polysiloxane synthesis, where the name (D4, D5 and D6) refers to the number of repeating Si—O units in the cyclic polysiloxane (i.e. 4, 5 or 6 repeating Si—O units in the cyclic polysiloxane respectively). From a health, safety, and environmental aspect it is preferred to limit the amount of cyclic polysiloxanes present in the coating composition. In one preferred embodiment, the hydrophilic modified polysiloxane contains less than 5% of cyclic polysiloxanes, preferably less than 2%, more preferably less than 1%. In one particularly preferred embodiment, the hydrophilic modified polysiloxane is free of cyclic polysiloxanes.

In one preferred embodiment the hydrophilic modified polysiloxane is a polyether modified polysiloxane.

Preferably, the polyether groups include at least 3 repeating units, such as at least 5 repeating units. In many interesting embodiments, the oligomers or polymers include 5-100 repeating units, such as 5-50, or 8-50, or 8-20 repeating units.

In some preferred embodiments, the polyether groups (i.e. oligomeric or polymeric groups) have a number average molecular weight (n) in the range of 100-2500 g/mol, such as in the range of 200-2000 g/mol, in particular in the range of 300-2000 g/mol, or in the range of 400-1000 g/mol.

Of particular interest are those polyether-modified polysiloxanes in which the relative weight of the polyether moieties is 5% or more of the total weight (e.g. 5-60%), such as 6% or more (e.g. 6-50%), in particular 10% or more (e.g. 10-40%) of the total weight of the polyether-modified polysiloxane.

In one variant hereof, the polyether-modified polysiloxane is a polysiloxane having grafted thereto poly(oxyalkylene) chains. An illustrative example of the structure of such polyether-modified polysiloxane is formula (VII):

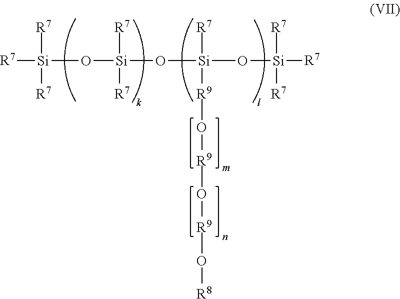

wherein each R⁷ is independently selected from C₁₋₅-alkyl (including linear or branched hydrocarbon groups) and aryl (e.g. phenyl (—C₆H₅)), in particular methyl;
each R⁸ is independently selected from —H, C₁₋₄-alkyl (e.g. —CH₃, —CH₂CH₃, —CH₂CH₂CH₃, —CH(CH₃)₂, —CH₂CH₂CH₂CH₃), phenyl (—C₆H₅), and C₁₋₄-alkylcarbonyl (e.g. —C(═O)CH₃, —C(═O)CH₂CH₃ and —C(═O)CH₂CH₂CH₃), in particular —H, methyl and —C(═O)CH₃;
each R⁹ is independently selected from C₂₋₅-alkylene (e.g. —CH₂CH₂—, —CH₂CH(CH₃), —CH₂CH₂CH₂—, —CH₂CH₂CH₂CH₂—, —CH₂CH(CH₂CH₃)—), arylene (e.g. 1,4-phenylene) and C₂₋₅-alkylene substituted with aryl (e.g. 1-phenyl ethylene), in particular from C₂₋₅-alkylene such as —CH₂CH₂— and —CH₂CH(CH₃)—);
k is 0-240, 1 is 1-60 and k+1 is 1-240; and
n is 0-50, m is 0-50 and m+n is 1-50.

In particular R⁷ is methyl;
each R⁸ is independently selected from —H or C₁₋₄-alkyl or —C(═O)CH₃;
each R⁹ is —CH₂CH₂—, or —CH₂CH₂CH₂—, or —CH₂CH(CH₃)—);
k is 0-240, 1 is 1-60 and k+1 is 1-240; and
n is 0-50, m is 0-50 and m+n is 1-50.

It is preferred if all R⁷ groups are the same.

Examples of commercially available polyether-modified polysiloxanes of this type are KF352A, KF353, KF945, KF6012, KF6017 from ShinEtsu. XIAMETER OFX-5220, DOWSIL OFX-5247, XIAMETER OFX-5329, XIAMETER OFX-5330 from DOW.

In another variant hereof, the polyether-modified polysiloxane is a polysiloxane having incorporated in the backbone thereof poly(oxyalkylene) chains.

An illustrative example of the structure of such hydrophilic-modified polysiloxanes is formula (VIII):

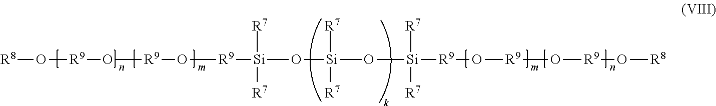

wherein each R⁷ is independently selected from C₁₋₅-alkyl (including linear or branched hydrocarbon groups) and aryl (e.g. phenyl (—C₆H₅)), in particular methyl;
each R⁸ is independently selected from —H, C₁₋₄-alkyl (e.g. —CH₃, —CH₂CH₃, —CH₂CH₂CH—CH(CH₃)₂, —CH₂CH₂CH₂CH₃), phenyl (—C₆H₅), and C₁-₄-alkylcarbonyl (e.g. —C(═O)CH₃, C(═O)CH₂CH₃ and —C(═O)CH₂CH₂CH₃), in particular —H, methyl and —C(═O)CH₃;
each R⁹ is independently selected from C₂₋₅-alkylene (e.g. —CH₂CH₂—, —CH₂CH(CH₃)—, —CH₂CH₂CH₂—, —CH₂CH₂CH₂CH₂—, —CH₂CH(CH₂CH₃)—), arylene (e.g. 1,4-phenylene) and C₂₋₅-alkylene substituted with aryl (e.g. 1-phenyl ethylene), in particular from C₂₋₅-alkylene such as —CH₂CH₂— and —CH₂CH(CH₃)—);
k is 0-240;
and n is 0-50, m is 0-50 and m+n is 1-50.
In particular, wherein R⁷ is methyl;
each R⁸ is independently selected from —H or C₁₋₄-alkyl or —C(═O)CH₃;
each R⁹ is —CH₂CH₂—, —CH₂CH(CH₃)—, or —CH₂CH₂CH₂—;
k is 0-240;
and n is 0-50, m is 0-50 and m+n is 1-50.

It is preferred if all R⁷ groups are the same.

Examples of commercially available hydrophilic-modified polysiloxanes of this type are DOWSIL 2-8692 and XIAMETER OFX-3667 from DOW.

In still another variant, the polyether-modified polysiloxane is a polysiloxane having incorporated in the backbone thereof polyoxyalkylene chains and having grafted thereto polyoxyalkylene chains. An illustrative example of the structure of such hydrophilic-modified polysiloxanes is formula (IX):

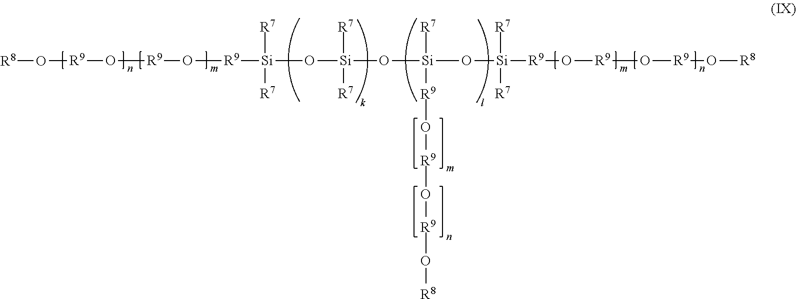

wherein each R⁷ is independently selected from C₁₋₅-alkyl (including linear or branched hydrocarbon groups) and aryl (e.g. phenyl (—C₆H₅)), In particular methyl;
each R⁸ is independently selected from —H, C₁₋₄-alkyl (e.g. —CH₃, —CH₂CH₃, —CH₂CH₂CH₃, —CH(CH₃)₂, —CH₂CH₂CH₂CH₃), phenyl (—C₆H₅), and C₁₋₄-alkylcarbonyl (e.g. —C(═O)CH₃, —C(═O)CH₂CH₃ and —C(═O)CH₂CH₂CH₃), in particular —H, methyl and —C(═O)CH₃;
each R⁹ is independently selected from C₂₋₅-alkylene (e.g. —CH₂CH₂—, —CH₂CH(CH₃)—, —CH₂CH₂CH₂—, —CH₂CH₂CH₂CH₂—, —CH₂CH(CH₂CH₃)—), arylene (e.g. 1,4-phenylene) and C₂₋₅-alkylene substituted with aryl (e.g. 1-phenyl ethylene), in particular from C₂₋₅-alkylene such as —CH₂CH₂— and —CH₂CH(CH₃)—);
k is 0-240, 1 is 1-60 and k+1 is 1-240;
n is 0-50, m is 0-50 and m+n is 1-50.

In particular, R⁷ is methyl;
each R⁸ is —H, or C₁₋₄-alkyl or —C(═O)CH₃;
each R⁹ is —CH₂CH₂—, —CH₂CH₂CH₂—, - or —CH₂CH(CH₃)—;
k is 0-240, y is 1-60 and x+y is 1-240;
n is 0-50, m is 0-50 and m+n is 1-50.

In the above structures (VII), (VIII) and (IX), the groups —CH₂CH(CH₃)—, —CH₂CH(CH₂CH₃)—, etc. may be present in any of the two possible orientations. Similarly, it should be understood that the segments present k and 1 times typically are randomly distributed in the polysiloxane structure.

In these embodiments and variants, the polyether or poly(oxyalkylene) is preferably selected from polyoxyethylene, polyoxypropylene and poly(oxyethylene-co-oxypropylene), which sometimes are referred to as polyethylene glycol, polypropylene glycol and poly(ethylene glycol-co-propylene glycol). Hence, in the above structures (VII), (VIII) and (IX), each R⁹ linking two oxygen atoms is preferably selected from —CH₂CH₂— and —CH₂CH(CH₃)—, whereas each R⁹ linking a silicon atom and an oxygen atom preferably is selected from C₂₋₅-alkyl.

In some embodiments of the above structures (VII), (VIII) and (IX), R⁸ is preferably not hydrogen.

It should be understood that the one or more polyether modified polysiloxanes may be of different types, e.g. two or more of the types described above.

In another preferred embodiment the hydrophilic modified polysiloxane comprises polyglycerol groups or pyrrolidone groups.

If present, the hydrophilic modified polysiloxane is preferably present in an amount of 1.0 to 30 wt %, more preferably 2.0 to 20 wt %, most preferred 4 to 15 wt %, relative to the total dry weight of the composition.

If present the hydrophilic modified polysiloxane is preferably present in an amount of 0.5-25 wt. %, more preferably 1.0-20 wt. %, most preferred 3-15 wt. % relative to the total weight of the coating composition.

Whilst it is within the ambit of the invention for a mixture of more than one hydrophilic modified polysiloxane to be present, it is preferably if only a single hydrophilic modified polysiloxane is present. Where there are two or more different types of hydrophilic modified polysiloxanes, these wt % ranges quoted above refer to the total sum of hydrophilic modified polysiloxane components.

### Hydrophobic Modified Polysiloxane Oil

The coating composition of the present invention optionally further comprises a hydrophobic modified polysiloxane oil. It should be understood that the hydrophobic modified polysiloxane does not contain curing reactive groups such as Si—OH groups, Si—OR (alkoxy) groups etc. that can react with the binder at relevant curing temperatures (0-40° C.), hence the hydrophobic modified polysiloxane is intended to be non-reactive in the curing reaction, in particular with respect to the binder components. Generally, this component is not regarded as part of the binder system. The functional groups on the hydrophobic modified polysiloxane should be chosen so that, depending on the curing mechanism, they do not react in the curing reaction.

Preferably the hydrophobic modified polysiloxane does not contain silicone reactive groups such as Si—OH groups, Si—OR (alkoxy) groups etc. that can react with the binder at relevant curing temperatures (0-40° C.).

A hydrophobic modified polysiloxane according to the present invention is a polysiloxane that is modified with hydrophobic groups to make it more hydrophobic compared to the corresponding unsubstituted polysiloxane having the same number of polysiloxane units. The skilled person will appreciate that by “hydrophobic” we mean a substance or group which repels water, i.e. not having an affinity for water. The hydrophobicity can be obtained by modification with hydrophobic groups such as alkyl, cycloalkyl and aryl groups. Typically, the hydrophobic-modified polysiloxane is an oil.

Preferred hydrophobic modified polysiloxanes are methylphenyl functional polysiloxanes and methyl aryl functional polysiloxanes.

If present, the hydrophobic modified polysiloxane is preferably present in an amount of 2.5 to 30 wt %, more preferably 5 to 25 wt %, relative to the total dry weight of the composition.

If present, the hydrophobic modified polysiloxane is preferably present in an amount of 1.0-30 wt. %, more preferably 4-20 wt. % relative to the total weight of the composition as a whole.

Whilst it is within the ambit of the invention for a mixture of more than one hydrophobic modified polysiloxane to be present, it is preferably if only a single hydrophobic modified polysiloxane is present. Where there are two or more different types of hydrophobic modified polysiloxanes, these wt % ranges quoted above refer to the total sum of hydrophobic modified polysiloxane components.

In one embodiment, the fouling release coating composition comprises a mixture of a hydrophilic modified polysiloxane and a hydrophobic modified polysiloxane. In this embodiment, each of the hydrophilic modified polysiloxane and hydrophobic modified polysiloxane may individually be present in an amount of 2.5 to 20 wt %, such as 5 to 15 wt %, relative to the total dry weight of the composition.

### Antifouling Agent/Biocide

The fouling release coating composition of the present invention may further comprise an antifouling agent/biocide.

The terms antifouling agent, biologically active compounds, antifoulant, biocide, toxicant are used in the industry to describe known compounds that act to prevent marine fouling on a surface. There terms may thus be used interchangeably here. If present, the antifouling agent may be inorganic, organometallic or organic. Preferably, if present the antifouling agent is an organometallic antifouling agent. Suitable antifouling agents are commercially available.

Examples of inorganic antifouling agents include copper and copper compounds such as copper oxides, e.g. cuprous oxide and cupric oxide; copper alloys, e.g. copper-nickel alloys; copper salts, e.g. copper thiocyanate and copper sulphide.

Examples of organometallic antifouling agents include zinc pyrithione; organocopper compounds such as copper pyrithione, copper acetate, copper di(ethyl 4,4,4-trifluoro acetoacetate), copper naphthenate, oxine copper, copper nonylphenolsulfonate, copper bis(ethylenediamine)bis(dodecylbenzensulfonate) and copper bis(pentachlorophenolate); dithiocarbamate compounds such as zinc bis(dimethyldithiocarbamate) [ziram], zinc ethylenebis(dithiocarbamate) [zineb], manganese ethylenebis(dithiocarbamate) [maneb] and manganese ethylene bis(dithiocarbamate) complexed with zinc salt [mancozeb].

Examples of organic antifouling agents include heterocyclic compounds such as 2-(tert-butylamino)-4-(cyclopropylamino)-6-(methylthio)-1,3,5-triazine [cybutryne], 4,5-dichloro-2-n-octyl-4-isothiazolin-3-one [DCOIT], encapsulated 4,5-dichloro-2-n-octyl-4-isothiazolin-3-one [DCOIT], 1,2-benzisothiazolin-3-one, 2-(thiocyanatomethylthio)-1,3-benzothiazole [benthiazole] and 2,3,5,6-tetrachloro-4-(mcthylsulphonyl) pyridine; urea derivatives such as 3-(3,4-dichlorophcnyl)-1,1-dimethylurea [diuron]; amides and imides of carboxylic acids, sulphonic acids and sulphenic acids such as N-(dichlorofluoromethylthio)phthalimide, N-dichlorofluoromethylthio-N′,N′-dimethyl-N-phenylsulfamide [dichlofluanid], N-dichlorofluoromethylthio-N′,N′-dimethyl-N-p-tolylsulfamide [tolylfluanid] and N-(2,4,6-trichlorophenyl)maleimide; other organic compounds such as pyridine triphenylborane [TPBP], amine triphenylborane, 3-iodo-2-propynyl N-butylcarbamate [iodocarb], 2,4,5,6-tetrachloroisophthalonitrile, p-((diiodomethyl)sulphonyl) toluene and 4-bromo-2-(4-chlorophenyl)-5-(trifluoromethyl)-1H-pyrrole-3-carbonitrile [tralopyril] and quaternary ammonium salts.

Other examples of antifouling agents include tetraalkylphosphonium halogenides, guanidine derivatives, imidazole containing compounds such as 4-[1-(2,3-dimethylphenyl)ethyl]-1H-imidazole [medetomidine] and derivatives thereof, macrocyclic lactones including avermectins and derivatives thereof such as ivermectine, spinosyns and derivatives thereof such as spinosad, capsaicins and derivatives thereof such as phenyl capsaicin, and enzymes such as oxidase, proteolytically, hemicellulolytically, cellulolytically, lipolytically and amylolytically active enzymes.

Preferred antifouling agents are zinc pyrithione, copper pyrithione, zinc ethylenebis(dithiocarbamate) [zineb], 4,5-dichloro-2-n-octyl-4-isothiazolin-3-one [DCOIT] and encapsulated 4,5-dichloro-2-n-octyl-4-isothiazolin-3-one [DCOIT]. Particularly preferred antifouling agents are zinc pyrithione and copper pyrithione, particularly copper pyrithione.

If present, the biocide may form 0.5 to 20% by weight of the total coating composition, preferably 0.75 to 10%, such as 1 to 5% by weight of the total coating composition.

If present, the biocide may form 0.5-20% by weight, preferably 1.0-15% by weight, more preferably 2.0-12% by weight relative to the total dry weight of the coating composition.

### Pigments and Fillers

The coating composition of the invention comprises at least one filler or pigment. The pigment(s) may be inorganic pigments, organic pigments or a mixture thereof. Inorganic pigments are preferred. The pigments may be surface treated.

Representative examples of pigments include black iron oxide, red iron oxide, yellow iron oxide, titanium dioxide, zinc oxide, carbon black, graphite, red molybdate, yellow molybdate, zinc sulfide, antimony oxide, sodium aluminium sulfosilicates, quinacridones, phthalocyanine blue, phthalocyanine green, indanthrone blue, cobalt aluminium oxide, carbazoledioxazine, isoindoline orange, bis-acetoaceto-tolidiole, benzimidazolone, quinaphthalone yellow, isoindoline yellow, tetrachloroisoindolinone, and quinophthalone yellow, metallic flake materials (e.g. aluminium flakes). Preferred pigments are black iron oxide, red iron oxide, yellow iron oxide, phthalocyanine blue and titanium dioxide. In one preferred embodiment the titanium dioxide is surface treaded with a silicone compound, a zirconium compound or a zinc compound.

Examples of fillers that can be used in the coating composition according to the present invention are zinc oxide, barium sulphate, calcium sulphate, calcium carbonate, dolomite (Microdol), mica, silicas or silicates (such as talc, feldspar, china clay and nepheline syenite) including fumed silica, bentonite and other clays, and solid silicone resins, which are generally condensed branched polysiloxanes. Some fillers such as fumed silica may have a thickening effect on the coating composition.

One example of a preferred filler is fumed silica fillers. The fumed silica fillers may have an untreated surface or a hydrophobically modified surface. Preferably the fumed silica filler has a hydrophobically modified surface. Examples of commercially available fumed silica fillers are TS-610, TS-530, EH-5, H-5, and M-5 from Cabot and Aerosil® R972, Aerosil® R974, Aerosil® R976, Aerosil® R104, Aerosil® R202, Aerosil® R208, Aerosil® R805, Aerosil® R812, Aerosil® 816, Aerosil® R7200, Aerosil® R8200, Aerosil® R9200, Aerosil® R711 from Evonik.

The amount of the at least one filler or pigment is preferably in the range 0.05 to 25 wt %, more preferably 0.1 to 15 wt % and still more preferably 0.5 to 10 wt %, based on the total weight of the coating composition.

The amount of the at least one filler or pigment is preferably in the range of 0.1-30 wt. %, more preferably 0.5-20 wt. % and still more preferably 1.0-15 wt. % based on the total dry weight of the coating composition.

### Additives

The coating composition of the present invention optionally comprises one or more additives. Examples of additives that may be present in the coating composition of the invention include reinforcing agents, rheology modifiers such as thixotropic agents, thickening agents and anti-settling agents, dispersing agents, wetting agents, coalescing agents, extenders, surfactants, binders, plasticizers, and dyes.

As the rheology modifier, a thixotropic agent suitable for water-based formulations, such as cellulosic thickeners, xanthan gum, guar gum, organically modified clays such as bentonite, hectorite and attapulgite clays, organic wax thixotropes based on castor oil and castor oil derivatives, polyamide waxes, urethane-based rheology modifiers and fumed silica may be employed.

Preferably thixotropic agents, thickening agents and anti-settling agents are each present in the composition of the invention in an amount of 0-10 wt %, more preferably 0.1-6 wt % and still more preferably 0.1-2.0 wt %, based on the total dry weight of the composition.

Coalescing agents may optionally be included. In a waterborne paint composition, the applied wet product is inhomogeneous, as opposed to a solventborne composition which will be homogenous when applied. In order to form a film the polysiloxane-based binder emulsion droplets must coalesce. Coalescing agents aid this process in the water phase. Examples of suitable coalescing agents are ester alcohol, benzyl alcohol, propylene glycol monomethyl ether (PM), propylene glycol propyl ether (PnP), dipropylene glycol n-butyl ether (DPnB), propylene glycol phenyl ether (PPh), tripropylene glycol n-butyl ether (TPnB), ethylene glycol propyl ether (EP), ethylene glycol butyl ether (EB), diacetone alcohol (DAA) and dipropylene glycol methyl ether (DPM).

In order to improve or facilitate dispersion of the pigments, fillers and biocides it may be desirable to incorporate wetting/dispersion additives that are compatible with a water-borne coating composition.

Examples of suitable dispersing agents are polyalkylene glycol, polyacrylamide, polyethercarboxylate and polycarboxylates.

### Solvent

The fouling release coating composition of the present invention is a waterborne composition, i.e. one comprising water as the solvent.

The fouling release coating composition of the present invention preferably comprises water as the sole solvent, i.e. the solvent consists of water. Thus, the coating compositions are thus preferably free of organic solvents and/or thinners.

Low amounts of organic co-solvents may be present such as ketones, alcohols, glycol ethers or other oxygen-containing solvents that are soluble or miscible with water.

The coating compositions comprise at least 10 wt % water, relative to the total weight of the composition as a whole. Preferably, the compositions comprise 10 to 60 wt % water, more preferably 20 to 50 wt %, such as 30 to 45 wt %, relative to the total weight of the composition as a whole.

### Composition and Paint

The present invention also relates to a process of preparing the fouling release coating composition as hereinbefore described, said process comprising the steps:
(i) Dispersing at least one pigment or filler in water to produce a dispersion; and subsequently
(ii) mixing the dispersion produced in step (i) and an aqueous polysiloxane-based binder emulsion to produce said coating composition.

The composition as described herein may be prepared in a suitable concentration for use, e.g. in spray painting. In this case, the composition is itself a paint. Alternatively, the composition may be a concentrate for preparation of paint. In this case, further solvent and optionally other components are added to the composition described herein to form paint. Preferred solvents are as hereinbefore described in relation to the composition.

After mixing, and optionally after addition of solvent, the fouling release coating composition or paint is preferably filled into a container. Suitable containers include cans, drums and tanks.

The fouling release coating composition may be supplied as a one-pack, as a two-pack or as a three-pack. Preferably the composition is supplied as a one-pack.

The fouling release coating composition and paint of the invention preferably has a solids content of 40-90 wt %, more preferably 50-80 wt % and still more preferably 55-70 wt %.

Preferably the fouling release coating composition and paint of the invention has a content of volatile organic compounds (VOC) of less than 80 g/L, more preferably less than 50 g/L, such as less than 25 g/L, e.g. 0 g/L. VOC content can be calculated (ASTM D5201-05A) or measured (US EPA method 24 or ISO 11890-1).

The coating composition of the present invention may be applied to any pre-treated coating layers designed for polysiloxane based fouling release coatings. Preferably, however, the coating composition is applied directly on top of an anticorrosive organic primer layer. The organic primer layer may be based on epoxy, modified epoxy (such as modified with polyvinyl butyral), polyurethane, acrylic, vinyl, polysiloxane, silicate and chlorinated rubber. Preferably the primer layer is an epoxy-based primer or a vinyl-based primer or a combination thereof.

The coating composition according to the present invention may be applied in one or two or more layers. Preferably the coating composition according to the present invention is applied in one layer.

Thus, in a further embodiment, the invention relates to a coating system comprising at least two layers A and B, where said layers A and B are adjacent and wherein layer A is an organic primer layer and wherein layer B comprises the waterborne fouling release coating composition of the invention.

The organic primer layer is preferably an epoxy primer layer. Such epoxy primers are well known in the art and can be purchased commercially.

The fouling release compositions of the present invention have a good adhesion to organic primers. There is thus normally no need to use a silicone-organic hybrid tie-coat. This means that the overall coating system will have one coating layer less and lower VOC. Thus, in a preferable embodiment, the coating systems of the invention do not comprise a tie-coat layer.

In one embodiment, the coating system as defined above comprises layer A and B wherein layer A and/or layer B have been cured.

The dry film thickness of each of the coating layers of the coating composition of the present invention is preferably 50-500 μm, more preferably 100-400 μm, most preferably 150-300 μm.

The fouling release coating composition of the present invention will typically be cured at a humidity of 20-90%, preferably 30-85%, more preferred 40-80%.

The invention also relates to substrates coated with a cured waterborne fouling release coting as hereinbefore defined as well as a process for applying a waterborne fouling release coating composition to a substrate comprising applying, e.g. by spraying, a waterborne fouling release coating composition as defined herein to a substrate and allowing the coating composition to cure.

The substrate is typically the surface of a marine structure, preferably a marine structure which is submerged when in use. Such surfaces may optionally have an organic primer layer coated thereon.

The fouling release coating composition and paint of the invention can be applied to a whole or part of any article surface which is subject to marine fouling. The surface may be permanently or intermittently underwater (e.g. through tide movement, different cargo loading or swell). The article surface will typically be the hull of a vessel or surface of a fixed marine object such as an oil platform or buoy. Application of the coating composition and paint can be accomplished by any convenient means, e.g. via painting (e.g. with brush or roller) or more preferably spraying the coating onto the article. Typically the surface will need to be separated from the seawater to allow coating. The application of the coating can be achieved as conventionally known in the art. After the coating is applied, it is preferably dried and/or cured.

### Applications

The fouling release coating of the present invention is typically applied to the surface of a marine structure, preferably the part of a marine structure which is submerged when in use. Typical marine structures include vessels (including but not limited to boats, yachts, motorboats, motor launches, ocean liners, tugboats, tankers, container ships and other cargo ships, submarines, and naval vessels of all types), pipes, shore and off-shore machinery, constructions and objects of all types such as piers, pilings, bridge substructures, water-power installations and structures, underwater oil well structures, nets and other aquatic culture installations, and buoys, etc. The surface of the substrate may be the “native” surface (e.g. the steel surface) or a surface which already has an organic primer layer coated thereon.

### EXAMPLES

### Materials

| Ingredient | Purpose | Properties |
|---|---|---|
| Coatosil DRI | Binder | See Table 1 |
| Dowsil 8005 | Binder | See Table 1 |
| Dowsil 8016 | Binder | See Table 1 |
| Powersil 577 Plus | Binder | See Table 1 |
| Hydrophobic | Additive oil | Methyl phenyl modified |
| modified | | polysiloxanes (see |
| polysiloxane oil | | Table 3) |
| Hydrophilic | Additive oil | PEG modified |
| modified | | polysiloxanes (see |
| polysiloxaneoil | | Table 2) |
| Copper Pyrithione | Biocide, Clean Bio from | Specific gravity |
| | Kolon life science | 1.82 g/cm³ |
| Tralopyril | Biocide, 4-bromo-2-(4- | Specific gravity 1.71 |
| | chlorophenyl)-5- | g/cm³ |
| | (trifluoromethyl)-1H- | |
| | pyrrole-3-carbonitrile | |
| | (Econea from Janssen) | |
| Zineb | Biocide, zinc ethane-1,2 | Specific gravity 1.96 |
| | diylbis(dithiocarbamate | g/cm³ |
| Medetomidine | Biocide, RS(-4-[1-(2,3- | |
| | Dimethylphenyl)ethyl] | |
| | 3H-imidazole | |
| Cu₂O | Biocide, Nordox | Specific gravity 5.8 |
| | cuprous oxide from | g/cm³ |
| | Nordox | |
| CuSCN | Biocide | Specific gravity 2.84 |
| | | g/cm³ |
| Cu metal | Biocide | Specific gravity 8.9 |
| | | g/cm³ |
| SeaNine 211 | Biocide, (4,5-dichloro-2- | Solid content: 30 wt. % |
| | n-octyl-4-isothiazolin-3- | in xylene |
| | one) from Lanxess | |
| SeaNine Ultra | Biocide, (encapsulated | |
| | 4,5-dichloro-2-n-octyl- | |
| | 4-isothiazolin-3-one) | |
| | from Lanxess | |
| Microdol (dolomite) | Filler | |
| Iron oxide red | Pigment | |
| (wt. %) | | |
| Surfactant | Multi-functional gemini | |
| | surfactant (Surfonyl | |
| | AD01) | |
| Dispersing agent | Sodium salt of acrylic | |
| | polymer in water | |
| | (Dispex AA4140) | |
| Rheology modifier | Non-ionic | Non-ionic |
| | urethane rheology | urethane rheology |
| | modifier (Acrysol ™RM | modifier |
| | 5000) | |
| Water | Solvent | |
| B0.5: α,ω- | Binder | Mw 24238 g/mol, |
| Hydroxypolydimethyl- | | Viscosity 440 mPas |
| siloxane, | | |
| B20: α,ω- | Binder | Mw 98279, Viscosity |
| Hydroxypolydimethyl- | | 22050 mPas |
| siloxane, | | |
| Hydrophobic silica | Additive | |
| Thixotropic agent | Additive | |
| Xylene | Solvent | |
| 1-Methoxy-2- | Solvent | |
| propanol | | |

TABLE 1
Properties of emulsions

| | Coatosil | Dowsil | Dowsil | Powersil 577 |
|---|---|---|---|---|
| | DRI | 8005 | 8016 | Plus |
| Tg (° C.) | −41 | NA | NA | NA |
| Weight | 45 | 45.9 | 60 | 57 |
| Solid (%) | | | | |
| Solvent | Water | Water | Water | Water |
| Density | 1.16 | 1-1.05 | 1 | 0.99 |
| (g/cm3) | | | | |
| Particle | 148 | 264 | 157 | NA |
| (droplet) | | | | |
| size (Z- | | | | |
| average, | | | | |
| nm) | | | | |
| Dynamic | 20 | 750 | 15 | 2300000 |
| Viscosity | | | | |
| (cps) | | | | |
| pH | 10.5-11.5 | 10.5-11.5 | 9-10 | 6.2 |
| CA Water | 76.06 ± 7.48 | 92.73 ± 9.03 | 82.32 ± 2.4 | 96.4 ± 12.11 |
| (°) | | | | |
| Surface | 28.83 ± 9.22 | 17.98 ± 6.97 | 35.52 ± 1.87 | 17.45 ± 5.91 |
| free energy | | | | |
| [mN/m] | | | | |

TABLE 2
Properties of Hydrophilic modified polysiloxanes

| Hydrophilic | | | | Terminal/ | | | |
|---|---|---|---|---|---|---|---|
| modified | Hydrophilic | no. of | Wt % | Pendant | | | |
| polysiloxane | goup | PEG¹ | PEG | PEG¹ | Mn | MW | PDI |
| 1 | PEG¹ | 4 | 20.4 | T + P | 7440 | 15557 | 2.09 |
| 2 | PEG¹ | 2 | 5.0 | T | 10114 | 20474 | 2.02 |
| 3 | PEG¹ | 2 | 25 | T | 12112 | 21992 | 1.82 |
| 4 | PEG¹ | 9 | | P | 2046 | 18027 | 8.81 |
| 5 | PEG¹ | 2 | | T | 2849 | 3425 | 1.20 |
| 6 | PEG¹ | 5 | 23.5 | P | 2587 | 7460 | 4.84 |

¹Polyethylene glycol

TABLE 3
Properties of Hydrophobic modified polysiloxanes.

| Hydrophobic modified | | | |
|---|---|---|---|
| polysiloxane¹ | Mn | Mw | PDI |
| Hydrophobic modified | 2805 | 5811 | 2.07 |
| polysiloxane 1 | | | |
| Hydrophobic modified | 4092 | 7008 | 1.71 |
| polysiloxane 2 | | | |
| Hydrophobic modified | 1715 | 2650 | 1.55 |
| polysiloxane 3 | | | |

¹Methyl phenyl modified polysiloxanes

### Determination Methods

### Particle Size Measurement

The particle size of emulsions was determined using a Malvern Zetasizer Nano S ZEN 1600 (Malvern Panalytical Ltd, UK) at a wavelength of 633 nm with a constant angle of 173° at room temperature.

### Determination of Polymer Average Molecular Weights Distribution

The hydrophilic and hydrophobic modified polysiloxane oils were characterised by Gel Permeation Chromatography (GPC) measurement. The molecular weight distribution (MWD) was determined using a Malvern Omnisec Resolve and Reveal system with two PLgel 5 μm Mixed-D columns from Agilent in series. The columns were calibrated by conventional calibration using narrow polystyrene standards. The analysis conditions were as set out in Table 4 below.

TABLE 4

| Detector | RI | |
|---|---|---|
| Wavelength | 640 | nm |
| Flow cell volume | 12 | μl |
| Column Set | Agilent PLgel 5 μm Mixed-D, | |
| | 2 columns in series | |
| Mobile Phase | THF | |
| Flow rate | 1 | ml/min |
| Injection volume | 100 | μl |
| Autosampler Temperature | 25° | C. |
| Column Oven Temperature | 35° | C. |
| Detector Oven Temperature | 35° | C. |

| | |
|---|---|
| Data Processing | Omnisec 5.1 |
| Calibration standards | Agilent Polystyrene Medium EasiVials (4 ml) |
| | Red, Yellow and Green |

Samples were prepared by dissolving an amount of hydrophobic or hydrophilic modified polysiloxane corresponding to 25 mg dry polymer in 5 ml THF. The samples were kept for a minimum of 3 hours at room temperature prior to sampling for the GPC measurements. Before analysis the samples were filtered through 0.45 μm Nylon filters. The weight-average molecular weight (Mw) and the number average molecular weight (Mn) is reported.

### Contact Angle and Surface Free Energy Measurement

The pure binders were applied directly to the PVC panels using a film applicator with a 300 μm clearance. The panels were used for static contact angle and surface free energy measurements via Drop Shape Analyzer. 5 different points were measured on each coating and the average was recorded.

### VOC

VOC content can be calculated (ASTM D5201-05A) or measured (US EPA method 24 or ISO 11890-1). All the coating compositions in the inventive examples have 0 g/L VOC calculated by ASTM D5201-05A.

### Testing of Antifouling Performance

PVC panels were coated with a first coat of Jotacote Universal N10 primer (two component polyamine cured epoxy-based primer) from Jotun A/S and a second coat of Safeguard Plus (two component polyamide cured vinyl epoxy-based primer) using airless spray within specified conditions. The coating compositions of the inventive and comparative examples were applied to the PVC panels pre-coated with organic primers using a film applicator with a 300 μm clearance.

The panels were used for static antifouling performance testing on a raft in Singapore, where the panels were submerged 0.3-1.3 m below the sea surface. The panels were evaluated by visual inspection using the scale shown below.

TABLE 5
Fouling rating based on area percent covered by fouling.

| Rating | Description | Area covered by fouling |
|---|---|---|
| 5 | Excellent | 0-10% |
| 4 | Good | 11-20% |
| 3 | Fair | 21-30% |
| 2 | Poor | 31-50% |
| 1 | Extremely Poor | More than 50% |

### Testing of Adhesion

### Adhesion Testing of Examples 1-72

PVC panels were coated with a coat of Jotacote Universal N10 primer (two component polyamine cured epoxy-based primer) from Jotun A/S or a coat of Safeguard Plus (two component polyamide cured vinyl epoxy-based primer) primer from Jotun A/S using airless spray within specified conditions. The coating compositions of the inventive and comparative examples were applied to the pre-coated panels using a film applicator with a 300 μm clearance. The panels were left at room temperature for 48 hours. Then, the panels were exposed to seawater at 25° C. prior to evaluation, the panels were removed from the seawater and left at room temperature for 24 hours. The cross-hatch method based on an unauthorized abstract of ISO 2409 was used to evaluate the adhesion property. A cutting tool was used to make 6 parallel cutting lines in vertical and horizontal directions. Then a soft brush was used to clean the surface very gently. Then the adhesion was evaluated based on the table below.

TABLE 6
Classification of adhesion test results.

| | | Percentage of coating are |
|---|---|---|
| Rating | Description | removed after cross-hatch test |
| 0 | Excellent | No defect and delamination |
| 1 | Very good | 0-5% |
| 2 | Good | 6-15% |
| 3 | Fair | 16-35% |
| 4 | Poor | 36-65% |
| 5 | Extremely poor | >65% |

### Adhesion Testing of Examples 73-79

PVC panels were coated with a coat of Safeguard Plus (two component polyamide cured vinyl epoxy-based primer) primer from Jotun A/S using airless spray within specified conditions.

The first layer of the coating compositions of the invention was applied to the pre-coated panels using a film applicator with a 300 μm clearance. After application of 1^{st} layer, the panels were kept at room temperature for 4 days and then the 2^{nd} coating layer coating was applied using a film applicator with a 300 μm clearance.

After 3 days, the panels were exposed to seawater at 20° C. The panels were removed from water and kept at room temperature 24 hours prior to evaluation. The adhesion was evaluated according to the method described above for examples 1-72.

### Adhesion Testing of Examples 80 and 81

PVC panels were coated with a coat of a two component, amine cured, waterborne epoxy-based primer using airless spray to a wet film thickness of 300 μm. The panels were dried for 48 hours at room temperature. The coating compositions of the inventive examples were applied to the pre-coated panels using a film applicator with a 300 μm clearance. The panels were left at room temperature for 48 hours. Then, the panels were exposed to seawater at 20° C. prior to evaluation, the panels were removed from the seawater and left at room temperature for 24 hours. The adhesion was evaluated according to the method described above for examples 1-72.

### Testing of Coating Film Properties Upon Exposure

ISO 4628-1 and ISO 4628-2 were applied to evaluate the degradation of coating films by assessing degree of cracking and blistering (Table 7). Coating compositions were applied at 300 μm WFT on the PVC panels pre-coated with Safeguard Plus primer. The panels were left at room temperature for 48 hours and then 24 hours at 52° C. Then, the panels were exposed to seawater at 40° C. Prior of each evaluation, the panels were removed from the seawater and left at room temperature for 24 hours and then 24 hours at 52° C.

TABLE 7
Degradation of coating films.

| | | | |
|---|---|---|---|
| Rating | Density of cracks | Density of blisters | Size of cracks |

| | | |
|---|---|---|
| 0 | None, i.e. no detectable cracks/blisters | Not visible under |
| | | ×10 magnification |
| 1 | Very few, i.e. small, barely significant | Only visible under |
| | number of cracks/blisters | up to ×10 |
| | | magnification |
| 2 | Few, i.e. small, but significant | Just visible with |
| | number of cracks/blisters | normal correct |
| | | vision |
| 3 | Moderate number of cracks/blisters | Clearly visible with |
| | | normal correct |
| | | vision |
| 4 | Considerable number of cracks/blisters | Large cracks |
| | | generally up to 1 |
| | | mm wide |
| 5 | Dense pattern of cracks/blisters | Very large cracks |
| | | generally more than |
| | | 1 mm wide |

### Preparation of Paint

For preparation of component B, Copper pyrithione (when present), water and the dispersing agent were added and gradually mixed with dissolver for 15 minutes. After that Microdol, surfactant, and more water were added and mixed for 15 minutes. Then, iron oxide red and water were added and mixed for 60-90 minutes. All ingredients were well grinded, the fineness of grind was ensured with grindometer. Target fineness of grind was <40 μm.

Afterward, component A (polysiloxane-binder emulsion) was added to component B and mixed for 2-3 minutes and at the final stage the component C (additive oils) was added and mixed for another 2-3 minutes.

In all prepared examples, component C (additive oils) are not being considered in calculation for PVC.

All examples had a homogenous and solid film formation.

TABLE 8
Example coating compositions (amounts are given in wt. %)

| | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|
| Component A | | | | | | | | | | |
| Coatosil DRI | 74.20 | 74.20 | 74.20 | 74.20 | 74.20 | 74.20 | 74.20 | 74.20 | 74.20 | 74.20 |
| Component B | | | | | | | | | | |
| Water | 4.02 | 4.02 | 4.02 | 4.02 | 4.02 | 4.02 | 4.02 | 4.02 | 4.02 | 4.02 |
| Dispersing agent | 1.12 | 1.12 | 1.12 | 1.12 | 1.12 | 1.12 | 1.12 | 1.12 | 1.12 | 1.12 |
| Microdol | 2.88 | 2.88 | 2.88 | 2.88 | 2.88 | 2.88 | 2.88 | 2.88 | 2.88 | 2.88 |
| Surfactant | 0.07 | 0.07 | 0.07 | 0.07 | 0.07 | 0.07 | 0.07 | 0.07 | 0.07 | 0.07 |
| Iron oxide red | 0.98 | 0.98 | 0.98 | 0.98 | 0.98 | 0.98 | 0.98 | 0.98 | 0.98 | 0.98 |
| Copper pyrithione | 1.73 | 1.73 | 1.73 | 1.73 | 1.73 | 1.73 | 1.73 | 1.73 | 1.73 | 1.73 |
| Component C | | | | | | | | | | |
| Hydrophobic Oil | | | | | | | | | | |
| Hydrophobic modified | 10 | 10 | 10 | | | | | | | |
| polysiloxane 1 | | | | | | | | | | |
| Hydrophobic modified | | | | 10 | 10 | 10 | | | | |
| polysiloxane 2 | | | | | | | | | | |
| Hydrophobic modified | | | | | | | 10 | 10 | 10 | |
| polysiloxane 3 | | | | | | | | | | |
| Hydrophilic Oil | | | | | | | | | | |
| Hydrophilic modified | 5 | | | 5 | | | 5 | | | |
| polysiloxane 1 | | | | | | | | | | |
| Hydrophilic modified | | 5 | | | 5 | | | 5 | | |
| polysiloxane 2 | | | | | | | | | | |
| Hydrophilic modified | | | 5 | | | 5 | | | 5 | |
| polysiloxane 3 | | | | | | | | | | |
| Total (wt. %) | 100 | 100 | 100 | 100 | 100 | 100 | 100 | 100 | 100 | 100 |
| PVC (%) | 4 | 4 | 4 | 4 | 4 | 4 | 4 | 4 | 4 | 4 |
| Test Results | | | | | | | | | | |
| Fouling rating | 5 | 5 | 5 | 5 | 5 | 5 | 5 | 5 | 5 | 4 |
| (3 months) | | | | | | | | | | |

### Comparative Example 1: An Uncoated PVC Panel was Submerged at the Same Time as the Test Panels in Table 8, Fouling Rating after 3 Months was 1

TABLE 9
Example coating compositions (amounts are given in wt. %)

| | Ex. 11 | Ex. 12 | Ex. 13 | Ex. 14 | Ex. 15 | Ex. 16 | Ex. 17 | Ex. 18 | Ex. 19 |
|---|---|---|---|---|---|---|---|---|---|
| Component A | | | | | | | | | |
| Coatosil DRI | 73 | 73 | 73 | 73 | 73 | 73 | 73 | 73 | 88 |
| Component B | | | | | | | | | |
| Water | 3.6 | 3.6 | 3.6 | 3.6 | 3.6 | 3.6 | 3.6 | 3.6 | 3.6 |
| Dispersing agent | 1.1 | 1.1 | 1.1 | 1.1 | 1.1 | 1.1 | 1.1 | 1.1 | 1.1 |
| Microdol | 5.1 | 5.1 | 5.1 | 5.1 | 5.1 | 5.1 | 5.1 | 5.1 | 5.1 |
| Surfactant | 0.2 | 0.2 | 0.2 | 0.2 | 0.2 | 0.2 | 0.2 | 0.2 | 0.2 |
| Iron oxide red | 1.8 | 1.8 | 1.8 | 1.8 | 1.8 | 1.8 | 1.8 | 1.8 | 1.8 |
| Copper pyrithione | 0.0 | 0.0 | 0.0 | 0.0 | 0.0 | 0.0 | 0.0 | 0.0 | 0.0 |
| Component C | | | | | | | | | |
| Hydrophobic Oil | | | | | | | | | |
| Hydrophobic modified | 10 | 10 | 10 | | | | | | |
| polysiloxane 1 | | | | | | | | | |
| Hydrophobic modified | | | | 10 | 10 | 10 | | | |
| polysiloxane 2 | | | | | | | | | |
| Hydrophobic modified | | | | | | | 10 | 10 | |
| polysiloxane 3 | | | | | | | | | |
| Hydrophilic Oil | | | | | | | | | — |
| Hydrophilic modified | 5 | | | 5 | | | | | |
| polysiloxane 1 | | | | | | | | | |
| Hydrophilic modified | | 5 | | | 5 | | 5 | | |
| polysiloxane 2 | | | | | | | | | |
| Hydrophilic modified | | | 5 | | | 5 | | 5 | |
| polysiloxane 3 | | | | | | | | | |
| Total (wt. %) | 100 | 100 | 100 | 100 | 100 | 100 | 100 | 100 | 100 |
| PVC (%) | 4 | 4 | 4 | 4 | 4 | 4 | 4 | 4 | 4 |
| Test Results | | | | | | | | | |
| Fouling rating | 5 | 5 | 5 | 5 | 4 | 4 | 5 | 5 | 3 |
| (1 month) | | | | | | | | | |

### Comparative Example 2: An Uncoated PVC Panel was Submerged at the Same Time as the Test Panels in Table 9, Fouling Rating after 1 Month was 1

TABLE 10
Example coating compositions (amounts are given in wt. %)

| | Ex. 20 | Ex. 21 | Ex. 22 | Ex. 23 |
|---|---|---|---|---|
| Component A | | | | |
| Dowsil 8005 | 71.1 | 0.0 | 89 | 0 |
| Dowsil 8016 | 0.0 | 69.2 | 0 | 89 |
| Component B | | | | |
| Water | 5.3 | 6.0 | 4.00 | 4.00 |
| Dispersing agent | 1.5 | 1.7 | 1.12 | 1.12 |
| Microdol | 3.8 | 4.3 | 2.87 | 2.87 |
| Surfactant | 0.1 | 0.1 | 0.07 | 0.07 |
| Iron oxide red | 1.3 | 1.5 | 0.98 | 0.98 |
| Copper pyrithione | 2.3 | 2.6 | 1.72 | 1.72 |
| Component C | | | | |
| Hydrophobic Oil | | | | |
| Hydrophobic | 10 | 10 | | |
| modified | | | | |
| polysiloxane 1 | | | | |
| Hydrophilic Oil | | | | |
| Hydrophilic modified | 5 | 5 | | |
| polysiloxane 4 | | | | |
| Total (wt. %) | 100 | 100 | 100 | 100 |
| PVC (%) | 4 | 4 | 4 | 4 |
| Test Results | | | | |
| Fouling rating (3 | 5 | 4 | 4 | 3 |
| months) | | | | |

### Comparative Example 3: An Uncoated PVC Panel was Submerged at the Same Time as the Test Panels in Table 11, Fouling Rating after 3 Months was 1

TABLE 11
Example coating compositions (amounts are given in wt. %)

| | Ex. 24 | Ex. 25 | Ex. 26 | Ex. 27 | Ex. 28 | Ex. 29 | Ex. 30 | Ex. 31 | Ex. 32 | Ex. 33 | Ex. 34 | Ex. 35 |
|---|---|---|---|---|---|---|---|---|---|---|---|---|
| Component A | | | | | | | | | | | | |
| Dowsil 8005 | 72 | 72 | 71 | 68 | 71 | 68 | 72 | 71 | 68 | 80.50 | 78.19 | 75.62 |
| Component B | | | | | | | | | | | | |
| Water | 6.53 | 6.53 | 7.33 | 8.17 | 7.33 | 8.17 | 6.53 | 7.33 | 8.17 | 7.26 | 8.14 | 9.08 |
| Dispersing agent | 1.82 | 1.82 | 2.05 | 2.28 | 2.05 | 2.28 | 1.82 | 2.05 | 2.28 | 2.02 | 2.28 | 2.53 |
| Microdol | 4.69 | 4.69 | 5.26 | 5.86 | 5.26 | 5.86 | 4.69 | 5.26 | 5.86 | 5.21 | 5.84 | 6.51 |
| Surfactant | 0.11 | 0.11 | 0.12 | 0.13 | 0.12 | 0.13 | 0.11 | 0.12 | 0.13 | 0.12 | 0.13 | 0.14 |
| Iron oxide red | 1.60 | 1.60 | 1.79 | 1.99 | 1.79 | 1.99 | 1.60 | 1.79 | 1.99 | 1.78 | 1.99 | 2.21 |
| Copper pyrithione | 2.81 | 2.81 | 3.16 | 3.52 | 3.16 | 3.52 | 2.81 | 3.16 | 3.52 | 3.12 | 3.51 | 3.91 |
| Component C | | | | | | | | | | | | |
| Hydrophilic Oil | | | | | | | | | | | | |
| Hydrophilic modified | 10 | | | | 10 | | | | 10 | | | |
| polysiloxane 1 | | | | | | | | | | | | |
| Hydrophilic modified | | 10 | | | | 10 | | 10 | | | | |
| polysiloxane 2 | | | | | | | | | | | | |
| Hydrophilic modified | | | 10 | 10 | | | 10 | | | | | |
| polysiloxane 3 | | | | | | | | | | | | |
| Total (wt. %) | | | | | | | | | | | | |
| PVC (%) | 8 | 8 | 12 | 16 | 12 | 16 | 8 | 12 | 16 | 12 | 16 | 8 |
| Test Results | | | | | | | | | | | | |
| Fouling rating | 5 | 5 | 5 | 5 | 5 | 4 | 5 | 5 | 5 | 3 | 3 | 3 |
| (4 months) | | | | | | | | | | | | |

### Comparative Example 4: An Uncoated PVC Panel was Submerged at the Same Time as the Test Panels in Table 11, Fouling Rating after 4 Months was 1

TABLE 12
Example coating compositions (amounts are given in wt. %)

| | Ex. 36 | Ex. 37 | Ex. 38 | Ex. 39 | Ex. 40 | Ex. 41 | Ex. 42 | Ex. 43 | Ex. 44 | Ex. 45 | Ex. 46 | Ex. 47 |
|---|---|---|---|---|---|---|---|---|---|---|---|---|
| Component A | | | | | | | | | | | | |
| Dowsil 8005 | 71 | 72 | 68 | 72 | 68 | 72 | 68 | 71 | 71 | 80.50 | 78.19 | 75.62 |
| Component B | | | | | | | | | | | | |
| Water | 7.33 | 6.53 | 8.17 | 6.53 | 8.17 | 6.53 | 8.17 | 7.33 | 7.33 | 7.26 | 8.14 | 9.08 |
| Dispersing agent | 2.05 | 1.82 | 2.28 | 1.82 | 2.28 | 1.82 | 2.28 | 2.05 | 2.05 | 2.02 | 2.28 | 2.53 |
| Microdol | 5.26 | 4.69 | 5.86 | 4.69 | 5.86 | 4.69 | 5.86 | 5.26 | 5.26 | 5.21 | 5.84 | 6.51 |
| Surfactant | 0.12 | 0.11 | 0.13 | 0.11 | 0.13 | 0.11 | 0.13 | 0.12 | 0.12 | 0.12 | 0.13 | 0.14 |
| Iron oxide red | 1.79 | 1.60 | 1.99 | 1.60 | 1.99 | 1.60 | 1.99 | 1.79 | 1.79 | 1.78 | 1.99 | 2.21 |
| Copper pyrithione | 3.16 | 2.81 | 3.52 | 2.81 | 3.52 | 2.81 | 3.52 | 3.16 | 3.16 | 3.12 | 3.51 | 3.91 |
| Component C | | | | | | | | | | | | |
| Hydrophobic Oil | | | | | | | | | | | | |
| Hydrophobic modified | 10 | | | | | 10 | 10 | | | | | |
| polysiloxane 2 | | | | | | | | | | | | |
| Hydrophobic modified | | 10 | | | 10 | | | 10 | | | | |
| polysiloxane 1 | | | | | | | | | | | | |
| Hydrophobic modified | | | 10 | 10 | | | | | 10 | | | |
| polysiloxane 3 | | | | | | | | | | | | |
| Total (wt. %) | 100 | 100 | 100 | 100 | 100 | 100 | 100 | 100 | 100 | 100 | 100 | 100 |
| PVC (%) | 12 | 8 | 16 | 8 | 16 | 8 | 16 | 12 | 12 | 12 | 16 | 8 |
| Test Results | | | | | | | | | | | | |
| Fouling rating | 3 | 4 | 5 | 3 | 5 | 4 | 3 | 4 | 4 | 3 | 3 | 3 |
| (4 months) | | | | | | | | | | | | |

### Comparative Example 5: An Uncoated PVC Panel was Submerged at the Same Time as the Test Panels in Table 12, Fouling Rating after 4 Months was 1

TABLE 13
Example coating compositions and adhesion testing results (amounts are given in wt. %)

| | Comp | Comp | | | | | |
|---|---|---|---|---|---|---|---|
| | Ex. 6¹ | Ex. 7¹ | Ex. 48 | Ex. 49 | Ex. 50 | Ex. 51 | Ex. 52 |
| Solvent-borne / Water-borne | SB | SB | WB | WB | WB | WB | WB |
| Component A | | | | | | | |
| Coatosil DRI | | | 74.20 | 73.2 | 74.24 | 73.24 | 69.26 |
| Dowsil 8005 | | | | | | | |
| B0.5: α,ω- | 27.8 | 26.3 | | | | | |
| Hydroxypolydimethylsiloxane, | | | | | | | |
| B20: α,ω- | 27.8 | 26.3 | | | | | |
| Hydroxypolydimethylsiloxane, | | | | | | | |
| Hydrophobic silica | 0.5 | 0.5 | | | | | |
| Iron oxide red | 3.5 | 3.5 | | | | | |
| Hydrophobic modified | 15.9 | 5.0 | | | | | |
| polysiloxane 1 | | | | | | | |
| Hydrophilic modified | 3.9 | 10.0 | | | | | |
| polysiloxane 6 | | | | | | | |
| Thixotropic agent | 0.7 | | | | | | |
| Xylene | 11.7 | 20.4 | | | | | |
| 1-Methoxy-2-propanol | 8.2 | | | | | | |
| Copper pyrithione | | 8.0 | | | | | |
| Component B | — | — | | | | | |
| Water | — | — | 4.02 | 3.6 | 4.00 | 3.58 | 5.85 |
| Dispersing agent | — | — | 1.12 | 1.1 | 1.11 | 1.09 | 1.64 |
| Microdol | — | — | 2.88 | 5.1 | 2.87 | 5.14 | 4.20 |
| Surfactant | — | — | 0.07 | 0.2 | 0.07 | 0.20 | 0.10 |
| Iron oxide red | — | — | 0.98 | 1.8 | 0.98 | 1.75 | 1.43 |
| Copper pyrithione | — | — | 1.73 | 0.0 | 1.73 | 0 | 2.52 |
| Ethyl silicate | 4.2 | 4.2 | | | | | |
| Component C | — | — | | | | | |
| Hydrophobic Oil | — | — | | | | | |
| Hydrophobic modified | — | — | 10 | 10 | 10 | 10 | 10 |
| polysiloxane 1 | | | | | | | |
| Hydrophilic Oil | — | — | | | | | |
| Hydrophilic modified | — | — | 5 | 5 | 5 | 5 | 5 |
| polysiloxane 2 | | | | | | | |
| Dibutyltin diacetate | 0.4 | 0.4 | | | | | |
| 1-Methoxy-2-propanol | 3.8 | 3.8 | | | | | |
| Total (wt. %) | 100 | 100 | 100 | 100 | 100 | 100 | 100 |
| PVC (%) | 1.2 | 7.26 | 4 | 4 | 8 | 8 | 12 |
| Test Results | | | | | | | |
| Adhesion on Jotacoat | 5 | 5 | 0 | 0 | 0 | NA | 0 |
| Uni. N10 (1 month) | | | | | | | |
| Adhesion on Safeguard | 5 | 5 | 0 | 0 | 0 | NA | 0 |
| Plus (1 month) | | | | | | | |
| | Ex. 53 | Ex. 54 | Ex. 55 | Ex. 56 | Ex. 57 | Ex. 58 | Ex. 59 |
| Solvent-borne / Water-borne | WB | WB | WB | WB | WB | WB | WB |
| Component A | | | | | | | |
| Coatosil DRI | 68.05 | 64.47 | 63.09 | | | | |
| Dowsil 8005 | | | | 70.7 | 73.2 | 72.17 | 71.12 |
| B0.5: α,ω- | | | | | | | |
| Hydroxypolydimethylsiloxane, | | | | | | | |
| B20: α,ω- | | | | | | | |
| Hydroxypolydimethylsiloxane, | | | | | | | |
| Hydrophobic silica | | | | | | | |
| Iron oxide red | | | | | | | |
| Hydrophobic modified | | | | | | | |
| polysiloxane 1 | | | | | | | |
| Hydrophilic | | | | | | | |
| modified polysiloxane 6 | | | | | | | |
| Thixotropic agent | | | | | | | |
| Xylene | | | | | | | |
| 1-Methoxy-2-propanol | | | | | | | |
| Copper pyrithione | | | | | | | |
| Component B | | | | | | | |
| Water | 5.16 | 7.64 | 6.67 | 5.3 | 3.6 | 4.77 | 4.22 |
| Dispersing agent | 1.56 | 2.13 | 2.02 | 1.5 | 1.1 | 1.33 | 1.28 |
| Microdol | 7.42 | 5.48 | 9.59 | 3.8 | 5.1 | 3.43 | 6.07 |
| Surfactant | 0.29 | 0.13 | 0.37 | 0.1 | 0.2 | 0.08 | 0.24 |
| Iron oxide red | 2.52 | 1.86 | 3.26 | 1.3 | 1.8 | 1.16 | 2.07 |
| Copper pyrithione | 0 | 3.29 | 0 | 2.3 | 0 | 2.06 | 0 |
| Ethyl silicate | | | | | | | |
| Component C | | | | | | | |
| Hydrophobic Oil | | | | | | | |
| Hydrophobic modified | 10 | 10 | 10 | 10 | 10 | 10 | 10 |
| polysiloxane 1 | | | | | | | |
| Hydrophilic Oil | | | | | | | |
| Hydrophilic modified | 5 | 5 | 5 | 5 | 5 | 5 | 5 |
| polysiloxane 2 | | | | | | | |
| Dibutyltin diacetate | | | | | | | |
| 1-Methoxy-2-propanol | | | | | | | |
| Total (wt. %) | 100 | 100 | 100 | 100 | 100 | 100 | 100 |
| PVC (%) | 12 | 16 | 16 | 4 | 4 | 8 | 8 |
| Test Results | | | | | | | |
| Adhesion on Jotacoat | NA | 0 | 0 | 2 | 2 | 0 | 0 |
| Uni. N10 (1 month) | | | | | | | |
| Adhesion on Safeguard | NA | 0 | 0 | 0 | 0 | 0 | 0 |
| Plus (1 month) | | | | | | | |

¹VOC-EU IED (2010/75/EU) (theoretical) 247 g/L

TABLE 14
Example coating compositions, degradation and adhesion testing results

| | Ex. 60 | Ex. 61 | Ex. 62 | Ex. 63 | Ex. 64 | Ex. 65 |
|---|---|---|---|---|---|---|
| Component A | | | | | | |
| Coatosil DRI | 64.48 | 75.86 | | | | |
| Dowsil 8005 | | | 66.43 | 78.15 | 61.14 | 71.93 |
| Component B | | | | | | |
| Water | 7.64 | 8.98 | 6.90 | 8.12 | 8.88 | 10.45 |
| Dispersing agent | 2.13 | 2.50 | 1.93 | 2.26 | 2.47 | 2.91 |
| Microdol | 5.48 | 6.45 | 4.96 | 5.83 | 6.37 | 7.50 |
| Surfactant | 0.13 | 0.15 | 0.12 | 0.14 | 0.15 | 0.17 |
| Iron oxide red | 1.86 | 2.19 | 1.69 | 1.99 | 2.17 | 2.55 |
| Copper pyrithione | 3.29 | 3.87 | 2.98 | 3.50 | 3.82 | 4.50 |
| Component C | | | | | | |
| Hydrophobic Oil | | | | | | |
| Hydrophobic modified | 10 | 0 | 10 | 0 | 10 | 0 |
| polysiloxane 1 | | | | | | |
| Hydrophilic Oil | | | | | | |
| Hydrophilic modified | 5 | 0 | 5 | 0 | 5 | 0 |
| polysiloxane 5 | | | | | | |
| Total (wt. %) | 100 | 100 | 100 | 100 | 100 | 100 |
| PVC (%) | 16 | 16 | 12 | 12 | 16 | 16 |
| Test Results | | | | | | |
| Density of cracks¹ | 0 | 0 | 0 | 0 | 0 | 0 |
| Density of blisters¹ | 0 | 0 | 0 | 0 | 0 | 0 |
| Size of cracks¹ | 0 | 0 | 0 | 0 | 0 | 0 |
| Adhesion on | 0 | 0 | 0 | 0 | 0 | 0 |
| Safeguard Plus² | | | | | | |

¹Testing after 6 months,
²Testing after 11 months

TABLE 15
Example coating compositions and adhesion testing
results (amounts are given in wt. %)

| | Ex. 66 | Ex. 67 | Ex. 68 | Ex. 69 | Ex. 70 | Ex. 71 | Ex. 72 |
|---|---|---|---|---|---|---|---|
| Component A | | | | | | | |
| Dowsil 8005 | 69.7 | 68.7 | 69.7 | 69.7 | 70.7 | 72.2 | 73.0 |
| Component B | | | | | | | |
| Water | 5.3 | 5.3 | 5.3 | 5.3 | 5.3 | 3.6 | 3.6 |
| Dispersing agent | 1.5 | 1.5 | 1.5 | 1.5 | 1.5 | 1.1 | 1.1 |
| Microdol | 3.8 | 3.8 | 3.8 | 3.8 | 3.8 | 5.1 | 5.1 |
| Surfactant | 0.1 | 0.1 | 0.1 | 0.1 | 0.1 | 0.2 | 0.2 |
| Iron oxide red | 1.3 | 1.3 | 1.3 | 1.3 | 1.3 | 1.8 | 1.8 |
| TiO₂ | | | | | 1 | | |
| Copper pyrithione | 2.3 | 2.3 | 2.3 | 2.3 | 2.3 | 0.0 | 0.0 |
| Tralopyril | 1 | | | | | | |
| Zineb | | 1 | | | | | |
| SeaNine Ultra | | | 1 | | | | |
| SeaNine 211 | | | | | | 1 | |
| Medetomidine | | | | | | | 0.2 |
| Cu₂O | | | | | | | |
| CuSCN | | 1 | | | | | |
| Cu metal | | | | 1 | | | |
| Component C | | | | | | | |
| Hydrophobic Oil | | | | | | | |
| Hydrophilic modified | 10 | 10 | 10 | 10 | 10 | 10 | 10 |
| polysiloxane 1 | | | | | | | |
| Hydrophilic Oil | | | | | | | |
| Hydrophilic modified | 5 | 5 | 5 | 5 | 5 | 5 | 5 |
| polysiloxane 2 | | | | | | | |
| Total (wt. %) | 100 | 100 | 100 | 100 | 100 | 100 | 100 |
| PVC (%)¹ | 4-5 | 4-5 | 4-5 | 4-5 | 4-5 | 4-5 | 4-5 |
| Adhesion on Safeguard | 2 | 0 | — | 0 | — | 0 | 2 |
| Plus (1 month) | | | | | | | |

TABLE 16
Examples of multilayer coating systems and adhesion testing results

| | Ex. 73 | Ex. 74 | Ex. 75 | Ex. 76 | Ex. 77 | Ex. 78 | Ex. 79 | Ex. 80 | Ex. 81 |
|---|---|---|---|---|---|---|---|---|---|
| Primer | Safeguard | Safeguard | Safeguard | Safeguard | Safeguard | Safeguard | Safeguard | WB | WB |
| layer | plus | plus | plus | plus | plus | plus | plus | primer | primer |
| 1^{st} layer of | Ex. 56 | Ex. 56 | Ex. 56 | Ex. 57 | Ex. 57 | Ex. 70 | Ex. 68 | Ex. 56 | Ex. 68 |
| topcoat | | | | | | | | | |
| 2^{nd} layer of | Ex. 56 | Ex. 57 | Ex. 68 | Ex. 57 | Ex. 56 | Ex. 56 | Ex. 56 | — | — |
| topcoat | | | | | | | | | |
| Adhesion | 0 | 0 | 0 | 0 | 0 | 0 | 0 | 0 | 0 |
| (1 month) | | | | | | | | | |

The following observations can be made with regards to the above examples:
Inventive examples 1-10 (Table 8) show that the biocidal fouling release formulations based on the polysiloxane-based binder emulsion Coatosil DRI have an antifouling effect compared with uncoated PVC panels (comparative example 1). Example 1-9 show that the antifouling performance was improved with the addition of hydrophobic and hydrophilic modified polysiloxane oils.
Inventive examples 11-19 (Table 9) show that non-biocidal formulation based on the polysiloxane-based binder emulsion Coatosil DRI improves the fouling release properties compared with uncoated PVC panels (comparative example 2). The antifouling performance was improved with the addition of hydrophobic and hydrophilic modified polysiloxane oils.
Inventive examples 20-23 (Table 10) show that biocidal and non-biocidal formulations based on the polysiloxane-based binder emulsions Dowsil 8005 and Dowsil 8016 improve the fouling release property compared with uncoated PVC panels (comparative example 3). The addition of hydrophilic and hydrophobic modified polysiloxane oils improved the antifouling performance.
Inventive examples 24-35 (Table 11) show that different PVC level does not seems to have any effect on the fouling release properties. Using only hydrophilic oils will give also excellent fouling release property without using any hydrophobic modified polysiloxane oils. Different hydrophilic modified polysiloxane oils can be used.
Inventive examples 36-47 (Table 12) show that different PVC level does not seems to have any effect on the fouling release property. Using only hydrophobic oils will also give excellent fouling release property without using any hydrophilic modified polysiloxane oils. Different hydrophobic modified polysiloxane oils can be used.
Inventive examples 48-59 (Table 13) show that water-borne coating compositions comprising different polysiloxane-based binder emulsions (Coatosil DRI and Dowsil 8005) with different PVC have surprisingly good adhesion to organic primers. This shows that a polysiloxane-organic hybrid tie-coat is not necessary when using the water-borne coating compositions of the invention.
Comparative examples 6 and 7 show that traditional solvent-based fouling release formulations where the polysiloxane-based binder is dissolved in an organic solvent give very poor adhesion to organic primers. Without being bound to any theory it is believed that the reason for the difference in adhesion is related to the film formation. There are big differences in the mechanism for film formation for solvent-borne and water-borne coating formulations. In solvent-borne formulations, the polymer chains are dissolved in the solvent, whereas in the water-borne formulation the polymeric binder is present as a droplets emulsified in water. Film formation of the solvent borne coatings are based on evaporation of solvent and crosslinking of the polymer chains. In water-borne technology, water will evaporate, and the polymeric droplets will coalesce and the polymer chains will crosslink and form a coating film. It is believed that this difference in the mechanism for the film formation is the reason why the water-borne fouling release coating of the invention have a good adhesion to organic primers while a traditional solvent-based fouling release coating will have a very poor adhesion to such primers.
Inventive examples 60-65 (Table 14) show that different polysiloxane binders with different PVC and with/without additive oils can withstand exposure in seawater at high temperature for a long time without any mechanical damage or cracking or blistering occurring in the coating film.
Inventive examples 66-72 (Table 15) show that different biocide combinations can be used in the waterborne fouling release formulations of the invention. All the coating compositions have good adhesion to the primer layer.
Examples 73-79 show that the waterborne formulations can be applied in several layers while still obtaining good adhesion.
Examples 73 and 76 show that two identical layers can be applied while maintaining good adhesion to the undercoat and between the fouling release coatings of the invention.
Examples 74 and 77 show that one fouling release layer may contain biocide while the other can be biocide free and still maintain desired adhesion.
Examples 75 and 79 show that one layer may have a higher biocide content, such as an additional organic biocide in one layer, while maintaining desired adhesion between layers.
Example 78 show that two coats of slightly different color might be applied on top of each other while maintaining good adhesion. This might be suitable e.g. in dock to visualize where to apply the next coat.
Examples 80 and 81 show that the waterborne fouling release coatings of the invention also have good adhesion to a waterborne primer.

1. A waterborne fouling release coating composition comprising:
(a) an aqueous polysiloxane-based binder emulsion, wherein said emulsion comprises polysiloxane-based binder droplets having an average droplet size of 4 to 1000 nm; and
(b) at least one pigment or filler;
wherein the coating composition comprises at least 10 wt % water relative to the total weight of the composition as a whole.

2. The waterborne fouling release coating composition as claimed in claim 1,
wherein said composition has a volatile organic compound (VOC) content of less than 80 g/L, preferably less than 50 g/L, more preferably less than 25 g/L, even more preferably 0 g/L.

3. The waterborne fouling release coating composition as claimed in claim 1, wherein said polysiloxane-based binder droplets have an average size of 50 to 350 nm, preferably 100 to 300 nm.

4. The waterborne fouling release coating composition as claimed in claim 1, wherein the polysiloxane-based binder is a linear or branched polysiloxane-based binder.

5. The waterborne fouling release coating compositions as claimed in claim 1, wherein said polysiloxane-based binder has the general formula (I) 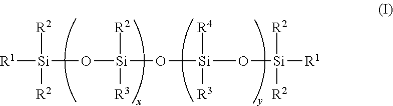
wherein
each R¹ is independently selected from a hydroxyl group, C₁₋₆-alkoxy group, C₁₋₆-hydroxyl group, C₁₋₆-epoxy containing group, C₁₋₆ amine group, C₁₋₁₀ alkyl group, C₆₋₁₀ aryl, C₇₋₁₀ alkaryl or O—Si(R⁵)_{3-z}(R⁶)_{z};
each R² is independently selected from C₁₋₁₀ alkyl, C₆₋₁₀ aryl, C₇₋₁₀ alkylaryl or C₁₋₆ alkyl substituted by poly(alkylene oxide) and/or a group as described for R¹;
each R³ and R⁴ is independently selected from C₁₋₁₀ alkyl, C₆₋₁₀ aryl, C₇₋₁₀ alkylaryl or C₁₋₆ alkyl substituted by poly(alkylene oxide);
each R⁵ is independently a hydrolysable group such as C₁₋₆ alkoxy group, an acetoxy group, an enoxy group or ketoxy group;
each R⁶ is independently selected from a C₁₋₆ alkyl group;
z is 0 or an integer from 1-2;
x is an integer of at least 2; and
y is an integer of at least 2.

6. The waterborne fouling release coating composition as claimed in claim 1, wherein the weight average molecular weight of the polysiloxane-based binder is 400-150 000, preferably 1000 to 140 000, more preferably 5000-130 000, even more preferably 10 000 to 120 000 g/mol.

7. The waterborne fouling release coating composition as claimed in claim 1, wherein said composition further comprises an additive oil, preferably a hydrophilic modified polysiloxane oil and/or a hydrophobic modified polysiloxane oil.

8. The waterborne fouling release coating composition as claimed in claim 1, wherein said composition further comprises a biocide.

9. The waterborne fouling release coating composition as claimed in claim 1, wherein said composition comprises 50 to 90 wt % of the aqueous polysiloxane-based binder emulsion, relative to the total weight of the composition as a whole.

10. A process for preparing the waterborne fouling release coating composition as defined in claim 1, said process comprising the steps:
(i) Dispersing at least one pigment or filler in water to produce a dispersion; and subsequently
(ii) mixing the dispersion produced in step (i) and an aqueous polysiloxane-based binder emulsion to produce said coating composition.

11. A coating system comprising at least two layers A and B, where said layers A and B are adjacent and wherein layer A is an organic primer layer and wherein layer B comprises the waterborne fouling release coating composition as claimed in claim 1.

12. The coating system as claimed in claim 11, wherein layer A is an epoxy primer layer.

13. The coating system as claimed in claim 11, wherein layer A and/or layer B have been cured.

14. A process for applying a waterborne fouling release coating composition to a substrate, the process comprising_;
applying, e.g. by spraying, the waterborne fouling release coating composition as defined in claim 1 to a substrate, and
allowing the coating composition to cure.

15. A substrate coated with a cured waterborne fouling release coating composition as claimed in claim 1.

16. The substrate as claimed in claim 15, wherein said substrate is the surface of a marine structure, preferably a marine structure which is submerged when in use.

17. A substrate coated with a coating system as claimed in claim 11.

18. The substrate as claimed in claim 17, wherein said substrate is the surface of a marine structure, preferably a marine structure which is submerged when in use.
